(19) United States
(12) Patent Application Publication
(10) Pub. No.: US 2010/0036041 A1
(43) Pub. Date: Feb. 11, 2010

(54) MOLDING MATERIALS COMPRISING HIGHLY CROSSLINKED ORGANIC NANOPARTICLES

(75) Inventors: Marc Schröder, Heidelberg (DE); Andreas Eipper, Ludwigshafen (DE); Matthias Scheibitz, Weinheim (DE); Hiroki Fukuhara, Mannheim (DE); Jens Assmann, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/445,138

(22) PCT Filed: Oct. 2, 2007
(86) PCT No.: PCT/EP2007/060419

§ 371 Date: Apr. 10, 2009

(30) Foreign Application Priority Data
Oct. 11, 2006 (EP) 06122060.4

(51) Int. Cl. C08L 67/00

(52) U.S. Cl. 524/502; 525/55

(57) ABSTRACT

Thermoplastic molding compositions, comprising

E) from 10 to 99.9% by weight of a thermoplastic polymer,

F) from 0.01 to 10% by weight of a copolymer obtainable via free-radical-initiated aqueous emulsion polymerization of ethylenically unsaturated monomers in the presence of at least one dispersing agent and of at least one free-radical initiator by the feed process, where the emulsion polymerization uses
from 70 to 99.5% by weight of α,β-monoethylenically unsaturated compounds [monomers A], and
from 0.5 to 30% by weight of compounds having at least two ethylenically unsaturated groups capable of free-radical copolymerization [monomers B], and also, if appropriate,
up to 5% by weight of α,β-monoethylenically unsaturated mono- or dicarboxylic acids having from 3 to 6 carbon atoms and/or their amides [monomers C],
   where the monomers A to C give a total of 100% by weight (entire amount of monomers) and the monomer feeds take place in such a way that ≧60% by weight of the entire amount of monomers B are fed to the polymerization mixture under polymerization conditions at a juncture after ≧60% by weight of the entire amount of monomer have been fed to the polymerization mixture under polymerization conditions,

from 0 to 70% by weight of further additives,

where the total of the percentages by weight of components A) to C) gives 100%.

The invention relates to thermoplastic molding compositions, comprising

A) from 10 to 99.9% by weight of a thermoplastic polymer,

B) from 0.01 to 10% by weight of a copolymer obtainable via free-radical-initiated aqueous emulsion polymerization of ethylenically unsaturated monomers in the presence of at least one dispersing agent and of at least one free-radical initiator by the feed process, where the emulsion polymerization uses
from 70 to 99.5% by weight of α,β-monoethylenically unsaturated compounds [monomers A], and
from 0.5 to 30% by weight of compounds having at least two ethylenically unsaturated groups capable of free-radical copolymerization [monomers B], and also, if appropriate,
up to 5% by weight of α,β-monoethylenically unsaturated mono- or dicarboxylic acids having from 3 to 6 carbon atoms and/or their amides [monomers C],
   where the monomers A to C give a total of 100% by weight (entire amount of monomers) and the monomer feeds take place in such a way that ≧60% by weight of the entire amount of monomers B are fed to the polymerization mixture under polymerization conditions at a juncture after ≧60% by weight of the entire amount of monomer have been fed to the polymerization mixture under polymerization conditions,

C) from 0 to 70% by weight of further additives,

where the total of the percentages by weight of components A) to C) gives 100%.

The invention further relates to the use of the molding compositions for production of moldings of any type and to the moldings thus obtainable.

Examples of inorganic nanoparticles in thermoplastics (PBT) are inter alia phyllosilicates (JP-A 03/62856) with high aspect ratio.

Spherical particles are known from WO 2001/72881, for example, and organically modified particles of said shape are known from WO 2005/82994.

Addition of the nanoparticles is intended in particular to improve the mechanical properties of thermoplastics.

In the more recent patent application DE-A 10 2006 020275.9, new processes for preparation of aqueous copolymer dispersions are proposed, these having low coagulate content.

Uses mentioned are production of adhesives, of sealing compounds, of polymer renders, of paper-coating compositions, of fiber nonwovens, of paints, and use as a coating composition.

It was therefore an object of the present invention to provide thermoplastic molding compositions (in particular polyesters and polyamides) which have improved mechanical properties.

Accordingly, the molding compositions defined in the introduction have been found.

Preferred embodiments are given in the subclaims.

In principle, the advantageous effect is apparent with plastics of any type. An example of a list of suitable thermoplastics A) is found in Kunststoff-Taschenbuch [Plastics Handbook] (ed. Saechtling), 1989 edition, which also mentions sources. Processes for the preparation of these thermoplastics are known per se to the person skilled in the art. Some preferred types of polymer will be explained in somewhat more detail below, preference being given to polyamides and polyesters.

1. Polyoxymethylenehomo- or -copolymers

These polymers are known per se to the person skilled in the art and are described in the literature.

Very generally, these polymers have at least 50 mol % of —CH₂O— repeat units in the main polymer chain.

The homopolymers are generally prepared via polymerization of formaldehyde or trioxane, preferably in the presence of suitable catalysts.

For the purposes of the invention, polyoxymethylene copolymers are preferred as component A, in particular those which alongside the —CH₂O— repeat units also have up to 50 mol %, preferably from 0.1 to 20 mol %, in particular from 0.3 to 10 mol %, and very particularly preferably from 2 to 6 mol %, of

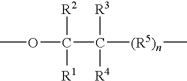

repeat units, where R¹ to R⁴, independently of each other, are a hydrogen atom, a C₁-C₄-alkyl group, or a halogen-substituted alkyl group having from 1 to 4 carbon atoms, and R⁵ is a —CH₂— group or —CH₂O— group, or is a C₁-C₄-alkyl- or C₁-C₄-haloalkyl-substituted methylene group or a corresponding oxymethylene group, and the value of n is in the range from 0 to 3. These groups can advantageously be introduced into the copolymers via ring opening of cyclic ethers. Preferred cyclic ethers are those of the formula

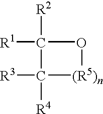

where R¹ to R⁵ and n are as defined above. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

Another suitable component A) is oxymethylene terpolymers which, by way of example, are prepared via reaction of trioxane and of one of the cyclic ethers described above with a third monomer, preferably bifunctional compounds of the formula

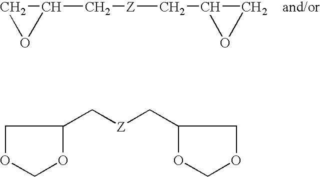

where Z is a chemical bond, —O—, —ORO— (R=C₁-C₈-alkylene or C₃-C₈-cycloalkylene).

Preferred monomers of this type are ethylene diglycide, diglycidyl ether, and diethers composed of glycidyl compounds and formaldehyde, dioxane or trioxane in a molar ratio of 2:1, and also diethers composed of 2 mol of glycidyl compound and 1 mol of an aliphatic diol having from 2 to 8 carbon atoms, e.g. diglycidyl ethers of ethylene glycol, 1,4-butanediol, 1,3-butanediol, 1,3-cyclobutanediol, 1,2-propanediol, and 1,4-cyclohexanediol, to mention just a few examples.

Processes for the preparation of the homo- and copolymers described above are known to the person skilled in the art and are described in the literature, making any further information here superfluous.

The melting points of the preferred polyoxymethylene copolymers are at least 150° C. and their molecular weights (weight-average) M, are in the range from 5000 to 200 000, preferably from 7000 to 150 000.

Particular preference is given to end-group-stabilized polyoxymethylene polymers whose chain ends have carbon-carbon bonds.

### 2. Polycarbonates and Polyesters

Suitable polycarbonates are known per se. They are obtainable by way of example by the processes of DE-B-1 300 266 via interfacial polycondensation or by the process of DE-A-14 95 730 via reaction of biphenyl carbonate with bisphenols. Preferred bisphenol is 2,2-di(4-hydroxyphenyl)propane, generally—and hereinafter—termed bisphenol A.

In place of bisphenol A, other aromatic dihydroxy compounds can also be used, in particular 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1 -di(4-hydroxyphenyl)ethane or 4,4-dihydroxydiphenyl, and mixtures of these.

Particularly preferred polycarbonates are those based on bisphenol A or bisphenol A together with up to 30 mol % of the abovementioned aromatic dihydroxy compounds.

The relative viscosity of these polycarbonates is generally in the range from 1.1 to 1.5, in particular from 1.28 to 1.4 (measured at 23° C. in a 0.5% strength by weight solution in dichloromethane).

Suitable polyesters are likewise known per se and described in the literature. They comprise, in their main chain, an aromatic ring which derives from an aromatic dicarboxylic acid. The aromatic ring can also have substitution, e.g. with halogen, such as chlorine and bromine, or with C₁-C₄-alkyl groups, such as methyl, ethyl, isopropyl, n-propyl, n-butyl, isobutyl or tert-butyl groups.

The polyesters may be prepared by reaction of aromatic dicarboxylic acids, their esters or other ester-forming derivatives thereof with aliphatic dihydroxy compounds, in a manner known per se.

These polyalkylene terephthalates are known per se and are described in the literature. Their main chain comprises an aromatic ring which derives from the aromatic dicarboxylic acid. The aromatic ring can also have substitution, e.g. with halogen, such as chlorine and bromine, or with C₁-C₄-alkyl groups, such as methyl, ethyl, isopropyl, n-propyl, n-butyl, isobutyl or tert-butyl groups.

These polyalkylene terephthalates may be prepared by reaction of aromatic dicarboxylic acids, their esters, or other ester-forming derivatives with aliphatic dihydroxy compounds, in a manner known per se.

Preferred dicarboxylic acids are naphthalene-2,6-dicarboxylic acid, terephthalic acid and isophthalic acid or mixtures of these. Up to 30 mol %, preferably not more than 10 mol %, of the aromatic dicarboxylic acids can be replaced by aliphatic or cycloaliphatic dicarboxylic acids, such as adipic acid, azelaic acid, sebacic acid, dodecanedioic acids and cyclohexanedicarboxylic acids.

Of the aliphatic dihydroxy compounds, preference is given to diols having from 2 to 6 carbon atoms, in particular 1,2-ethanediol, 1,4-butanediol, 1,6-hexanediol, 1,4-hexanediol, 1,4-cyclohexanediol, 1,4-cyclohexanedimethanol and neopentyl glycol or mixtures of these.

Particularly preferred polyesters (A) are polyalkylene terephthalates derived from alkanediols having from 2 to 6 carbon atoms. Among these, particular preference is given to polyethylene terephthalate and polybutylene terephthalate and to mixtures of these, and it is also possible here to use up to 50% by weight, based on A), of polyethylene terephthalate in the form of recycled material.

The viscosity number of the polyesters (A) is generally in the range from 60 to 220, preferably from 100 to 150 ml/g (measured in a 0.5% strength by weight solution in a mixture of phenol and o-dichlorobenzene (weight ratio 1:1) at 25° C.).

Particular preference is given to polyesters whose carboxy end group content is up to 100 meq/kg of polyester, preferably up to 50 meq/kg of polyester, and in particular up to 40 meq/kg of polyester. These polyesters can by way of example be prepared by the process of DE-A 44 01 055. The carboxy end group content is usually determined via titration methods (e.g. potentiometry).

Another group which may be mentioned is that of fully aromatic polyesters which derive from aromatic dicarboxylic acid and from aromatic dihydroxy compounds.

Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

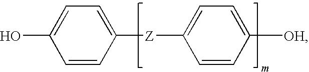

where Z is an alkylene or cycloalkylene group having up to 8 carbon atoms, an arylene group having up to 12 carbon atoms, a carbonyl group, a sulfonyl group, an oxygen or sulfur atom, or a chemical bond, and m is from 0 to 2. The phenylene groups of the compounds may also have substitution by C₁-C₆-alkyl or -alkoxy groups and fluorine, chlorine or bromine.

### Examples of Parent Compounds for These Compounds Are

dihydroxybiphenyl,
di(hydroxyphenyl)alkane,
di(hydroxyphenyl)cycloalkane,
di(hydroxyphenyl) sulfide,
di(hydroxyphenyl) ether,
di(hydroxyphenyl) ketone,
di(hydroxyphenyl) sulfoxide,
α,α′-di(hydroxyphenyl)dialkylbenzene,
di(hydroxyphenyl) sulfone, di(hydroxybenzoyl)benzene,
resorcinol, and
hydroquinone, and also the ring-alkylated and ring-halogenated derivatives of these.

Among these, preference is given to
4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and 2,2-di(3′-chloro-4′-hydroxyphenyl)propane,
   and in particular to
2,2-di(4′-hydroxyphenyl)propane
2,2-di(3′,5-dichlorodihydroxyphenyl)propane,
1,1 -di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyether-esters. Products of this type are known per se and are described in the literature, e.g. in U.S. Pat. No. 3,651,014. Corresponding products are also available commercially, e.g. Hytrel® (DuPont).

Preferred dicarboxylic acids that may be mentioned are naphthalenedicarboxylic acid, terephthalic acid, and isophthalic acid, and mixtures of these. Up to 10 mol % of the aromatic dicarboxylic acids can be replaced by aliphatic or cycloaliphatic dicarboxylic acids, such as adipic acid, azelaic acid, sebacic acid, dodecanedioic acids, and cyclohexanedicarboxylic acids.

Among the aliphatic dihydroxy compounds, preference is given to diols having from 2 to 6 carbon atoms, in particular 1,2-ethanediol, 1,4-butanediol, 1,6-hexanediol, 1,4-hexanediol, 1,4-cyclohexanediol, and neopentyl glycol, and mixtures of these.

Particularly preferred polyesters that may be mentioned are polyalkylene terephthalates which derive from alkanediols having from 2 to 6 carbon atoms. Among these, particular preference is given to polyethylene terephthalate, polyethylene naphthalate, and polybutylene terephthalate.

The viscosity number of the polyesters is generally in the range from 60 to 200 ml/g (measured in 0.5% strength by weight solution in a phenol/o-dichlorobenzene mixture (ratio by weight 1:1) at 23° C.).

### 3. Polyolefins

Mention may be made here very generally of polyethylene and polypropylene, and also of copolymers based on ethylene or propylene, if appropriate also with higher α-olefins. Corresponding products are obtainable with trademarks Lupolen® or Hostalen®/Moplen® from BASELL.

### 4. Polymethacrylates

Among these, particular mention is made of polymethyl methacrylate (PMMA), and also of copolymers based on methyl methacrylate with up to 40% by weight of further copolymerizable monomers, for example the materials obtainable as Plexiglas®.

### 5. Polyamides

The polyamides of the inventive molding compositions generally have a viscosity number of from 90 to 350 ml/g, preferably from 110 to 240 ml/g, determined in a 0.5% strength by weight solution in 96% strength by weight sulfuric acid at 25° C., according to ISO 307.

Preference is given to semicrystalline or amorphous resins with a molecular weight (weight average) of at least 5000, as described, for example, in U.S. Pat. Nos. 2,071,250, 2,071,251, 2,130,523, 2,130,948, 2,241,322, 2,312,966, 2,512,606 and 3,393,210.

Examples of these are polyamides derived from lactams having from 7 to 13 ring members, such as polycaprolactam, polycapryllactam and polylaurinlactam, and polyamides obtained by reacting dicarboxylic acids with diamines.

Dicarboxylic acids which may be employed are alkanedicarboxylic acids having from 6 to 12, in particular from 6 to 10, carbon atoms and aromatic dicarboxylic acids. Just a few of the acids that may be mentioned here are, adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and m-xylylenediamine, di(4-aminophenyl)methane, di(4-aminocyclohexyl)methane, 2,2-di(4-am inophenyl)propane or 2,2-di(4-aminocyclohexyl)propane.

Preferred polyamides are polyhexamethylene adipamide, polyhexamethylene sebacamide, polycaprolactam and copolyamide 6/66, especially with a proportion of from 5 to 95% by weight of caprolactam units.

Examples of other polyamides are those obtainable, for example, by condensing 1,4-diaminobutane with adipic acid at elevated temperature (nylon-4,6). Preparation processes for polyamides of this structure are described, for example, in EP-A 38 094, EP-A 38 582 and EP-A 39 524.

Polyamides which are obtainable by copolymerizing two or more of the abovementioned monomers, and mixtures of a number of polyamides in any desired mixing ratio, are also suitable.

Furthermore, semi-aromatic copolyamides such as PA 6/6T and PA 66/6T have proven paraticularly advantageous when their triamine content is less than 0.5% by weight, preferably less than 0.3% by weight (see EP-A 299 444).

The preferred semi-aromatic copolyamides with low triamine content can be prepared in accordance with the processes described in EP-A 129 195 and 129 196.

It is, of course, also possible to use mixtures (blends) of these polymers.

### 6. Vinylaromatic Polymers

The molecular weight of these polymers, which are known per se and are commercially available, is generally in the range from 1500 to 2 000 000, preferably in the range from 70 000 to 1 000 000.

Vinylaromatic polymers which may be mentioned merely as examples here are those made from styrene, chlorostyrene, cc-methylstyrene and p-methylstyrene; comonomers, such as (meth)acrylonitrile or (meth)acrylates, may also be involved in the construction in subordinate proportions (preferably not more than 20% by weight, in particular not more than 8% by weight). Particularly preferred vinylaromatic polymers are polystyrene and impact-modified polystyrene. Mixtures of these may, of course, also be employed. They are preferably prepared by the process described in EP-A-302 485.

Preferred ASA polymers are built up from a soft or rubber phase composed of a graft polymer of:

A₁ from 50 to 90% by weight of a graft base, based on
A₁₁ from 95 to 99.9% by weight of a C₂-C₁₀-alkyl acrylate and
A₁₂ from 0.1 to 5% by weight of a bifunctional monomer having two non-conjugated olefinic double bonds, and

A₂ from 10 to 50% by weight of a graft composed of
A₂₁ from 20 to 50% by weight of styrene or substituted styrenes of the general formula I or a mixture of these, and
A₂₂ from 10 to 80% by weight of acrylonitrile, methacrylonitrile, acrylates or methacrylates or a mixture of these,
   mixed with a hard matrix based on a SAN copolymer A₃) of:
A₃₁ from 50 to 90% by weight, preferably from 55 to 90% by weight, and in particular from 65 to 85% by weight, of styrene and/or substituted styrenes of the general formula I and
A₃₂ from 10 to 50% by weight, preferably from 10 to 45% by weight, and in particular from 15 to 35% by weight, of acrylonitrile and/or methacrylonitrile.

Component A₁) is an elastomer whose glass transition temperature is below −20° C., in particular below −30° C.

For preparing the elastomer, the main monomers A₁₁) employed are acrylates having from 2 to 10 carbon atoms, in particular from 4 to 8 carbon atoms. Examples of particularly preferred monomers are here tert-butyl, isobutyl and n-butyl acrylates and 2-ethylhexyl acrylate, of which the two last named are particularly preferred.

Besides these acrylates, from 0.1 to 5% by weight, in particular from 1 to 4% by weight, based on the total weight A₁₁+A₁₂, of a polyfunctional monomer having at least two non-conjugated olefinic double bonds is employed. Of these compounds, preference is given to bifunctional compounds, i.e. having two non-conjugated double bonds. Examples are divinylbenzene, diallyl fumarate, diallyl phthalate, triallyl cyanurate, triallyl isocyanurate, tricyclodecenyl acrylate and dihydrodicyclopentadienyl acrylate, of which the two last named are particularly preferred.

Processes for preparing the graft base A₁ are known per se and are described, for example, in DE-B 1 260 135. Corresponding products are also commercially available.

Preparation by emulsion polymerization has proven particularly advantageous in some cases.

The precise conditions of polymerization, in particular the type, method of feeding, and amount of emulsifier are preferably selected so that the acrylate latex, which is at least partially crosslinked, has a mean particle size (weight average d₅₀) in the range from about 200 to 700 nm, in particular from 250 to 600 nm. The latex preferably has a narrow particle size distribution, i.e. the quotient

$$Q = \frac{{d}_{90} - {d}_{10}}{{d}_{50}}$$

is preferably smaller than 0.5, in particular smaller than 0.35.

The proportion of the graft base A₁ in the graft polymer A₁+A₂ is from 50 to 90% by weight, preferably from 55 to 85% by weight, and in particular from 60 to 80% by weight, based on the total weight of A₁+A₂.

A graft shell A₂ is grafted onto the graft base A₁, the graft shell A₂ being obtainable by copolymerization of
A₂₁ from 20 to 90% by weight, preferably from 30 to 90% by weight, and in particular from 30 to 80% by weight, of styrene or substituted styrenes of the general formula

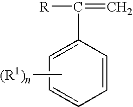

where R is alkyl radicals having from 1 to 8 carbon atoms, hydrogen atoms, or halogen atoms, and R¹ is alkyl radicals having from 1 to 8 carbon atoms, or halogen atoms, and the value of n is 0, 1, 2, or 3, and
A₂₂ from 10 to 80% by weight, preferably from 10 to 70% by weight, and in particular from 20 to 70% by weight, of acrylonitrile, methacrylonitrile, acrylates or methacrylates or a mixture of these.

Examples of substituted styrenes are α-methylstyrene, p-methylstyrene, p-chlorostyrene and p-chloro-α-methylstyrene, and of these styrene and α-methylstyrene are preferred.

Preferred acrylates and/or methacrylates are those whose homopolymers and/or copolymers with the other monomers of component A₂₂) have glass transition temperatures above 20° C.; in principle, however, other acrylates may also be employed, preferably in amounts which result in an overall glass transition temperature T_{g} of above 20° C. for the component A₂.

Particular preference is given to esters formed from acrylic or methacrylic acid with C₁-C₈ alcohols and esters comprising epoxy groups, such as glycidyl acrylate and/or glycidyl methacrylate. Examples of very particularly preferred compounds are methyl methacrylate, tert-butyl methacrylate, glycidyl methacrylate and n-butyl acrylate, where the last named is preferably not employed in an excessively high proportion, because of its property of forming polymers with very low T_{g}.

The graft shell A₂) can be prepared in one step of a process or in a plurality of these, e.g. two or three, the overall formulation remaining unaffected thereby.

The graft shell is preferably prepared in emulsion, as described, for example, in DE Patent 12 60 135, DE-A-32 27 555, DE-A-31 49 357 and DE-A-34 14 118.

Depending on the selected conditions, the graft copolymerization gives rise to a certain proportion of free copolymers of styrene and/or substituted styrene derivatives and (meth)acrylonitrile and/or (meth)acrylates.

The graft copolymer A₁+A₂ generally has a mean particle size of from 100 to 1000 nm, in particular from 200 to 700 nm, (d₅₀ weight average). The conditions for preparing the elastomer A₁) and for the grafting are preferably therefore selected so as to give particle sizes in this range. Measures for this are known and are described, for example, in DE Patent 1 260 135 and in DE-A-28 26 925, and in Journal of Applied Polymer Science, Vol. 9 (1965), pp. 2929 to 2938. The increase in particle size of the elastomer latex can be brought about, for example, by agglomeration.

For the purposes of this invention, the free, non-grafted homo- and copolymers arising during the graft copolymerization to prepare the component A₂) are counted as part of the graft polymer (A₁+A₂).

Some preferred graft polymers are listed below:
1: 60% by weight of graft base A₁ made from
A₁₁ 98% by weight of n-butyl acrylate and

A₁₂ 2% by weight of dihydrodicyclopentadienyl acrylate and 40% by weight of graft shell A₂ made from
A₂₁ 75% by weight of styrene and A₂₂ 25% by weight of acrylonitrile

2: Graft base as in 1, with 5% by weight of a first graft shell of styrene and
35% by weight of a second graft made from
A₂₁ 75% by weight of styrene and
A₂₂ 25% by weight of acrylonitrile

3: Graft base as in 1, with 13% by weight of a first graft of styrene and 27% by weight of a second graft made from styrene and acrylonitrile in a weight ratio of 3:1

The products present as component A₃) can be prepared, for example, by the process described in DE-B-10 01 001 and DE-B-10 03 436. Such copolymers are also available commercially. The weight average of the molecular weight, determined by light scattering, is preferably in the range from 50 000 to 500 000, in particular from 100 000 to 250 000.

The weight ratio of (A₁+A₂):A₃ is in the range from 1:2.5 to 2.5:1, preferably from 1:2 to 2:1 and in particular from 1:1.5 to 1.5:1.

SAN polymers suitable as component A) are described above (see A₃₁ and A₃₂).

The viscosity number of the SAN polymers measured according to DIN 53 727 as 0.5% strength by weight solution in dimethylformamide at 23° C. is generally in the range from 40 to 100 ml/g, preferably from 50 to 80 ml/g.

ABS polymers present as polymer (A) in the inventive multiphase polymer mixtures have the same construction as described above for ASA polymers. In place of the acrylate rubber A₁) of the graft base of the ASA polymer, conjugated dienes are usually employed, preferably giving the following formulation for the graft base A₄:
A₄₁ from 70 to 100% by weight of a conjugated diene and
A₄₂ from 0 to 30% by weight of a bifunctional monomer having two non-conjugated olefinic double bonds

In the formulation, the graft A₂ and the hard matrix of the SAN copolymer A₃) remain unchanged. Such products are commercially available, and the preparation processes are known to the person skilled in the art, and further details here would therefore be superfluous.

The weight ratio of (A₄+A₂):A₃ is in the range from 3:1 to 1:3, preferably from 2:1 to 1:2.

Particularly preferred formulations of the thermoplastic molding compositions contain, as component A), a mixture of:
A₁) from 10 to 90% by weight of a polybutylene terephthalate
A₂) from 0 to 40% by weight of a polyethylene terephthalate

A₃) from 1 to 40% by weight of an ASA or ABS polymer or mixtures of these.

Products of this type are available from BASF AG under the trademark Ultradur® S (previously Ultrablend® S).

Other preferred formulations of component A) comprise
A₁) from 10 to 90% by weight of a polycarbonate
A₂) from 0 to 40% by weight of a polyester, preferably polybutylene terephthalate,
A₃) from 1 to 40% by weight of an ASA or ABS polymer or mixtures of these.

Products of this type are obtainable with the BASF AG trademark Terblend®.

### 7. Polyarylene Ethers

Preferred polyarylene ethers A) are either polyarylene ethers per se, polyarylene ether sulfides, polyarylene ether sulfones, or polyarylene ether ketones. The arylene groups of these can be identical or different and, independently of one another, are an aromatic radical having from 6 to 18 carbon atoms. Examples of suitable arylene radicals are phenylene, bisphenylene, terphenylene, 1,5-naphthylene, 1,6-naphthylene, 1,5-anthrylene, 9,10-anthrylene, or 2,6-anthrylene. Among these, preference is given to 1,4-phenylene and 4,4′-biphenylene. These aromatic radicals are preferably unsubstituted radicals. However, they can bear one or more substituents. Examples of suitable substituents are alkyl, arylalkyl, aryl, nitro, cyano, or alkoxy groups, and also heteroaromatics, such as pyridine, and halogen atoms. Among the preferred substituents are alkyl radicals having up to 10 carbon atoms, e.g. methyl, ethyl, isopropyl, n-hexyl, isohexyl, C₁-C₁₀-alkoxy radicals, such as methoxy, ethoxy, n-propoxy, n-butoxy, aryl radicals having up to 20 carbon atoms, e.g. phenyl or naphthyl, and also fluorine and chlorine. These can have linkage to one another not only by way of —O— but also by way of —S—, —SO—, —SO₂—, —CO—, —N═N—, —COO—, an alkylene radical, or a chemical bond. The arylene groups in the polyarylene ethers (B) can also have linkage to one another by way of different groups.

Among the preferred polyarylene ethers are those having repeat units of the general formula I

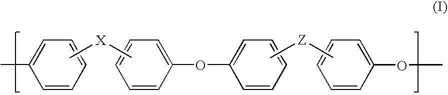

It is also possible to use their ring-substituted derivatives. Preferred substituents that can be used are C₁-C₆-alkyl, such as methyl, ethyl, or tert-butyl, C₁-C₆-alkoxy, such as methoxy or ethoxy, aryl, in particular phenyl, or chlorine or fluorine. The variable X can be —SO₂—, —SO—, —S—, —O—, CO, —N═N—, —RC═CR^{a}—, —CR^{b}R^{c}—, or a chemical bond. The variable Z can be —SO₂—, —SO—, —CO—, —O—, —N═N—, or —RC═CR^{a}. Each of R and R^{a} here is hydrogen, C₁-C₆-alkyl, e.g. methyl, n-propyl or n-hexyl, C₁-C₆-alkoxy, including methoxy, ethoxy or butoxy, or aryl, in particular phenyl. Each of the radicals R^{b} and R^{c} can be hydrogen or a C₁-C₆-alkyl group, in particular methyl. However, they can also have linkage to one another to form a C₄-C₁₀-cycloalkyl ring, preferably a cyclopentyl or cyclohexyl ring, which in its turn can have substitution by one or more alkyl groups, preferably methyl. Alongside this, R^{b} and R^{c} can also be a C₁-C₆-alkoxy group, e.g. methoxy or ethoxy, or an aryl group, particularly phenyl. Each of the abovementioned groups can in turn have substitution by chlorine or fluorine.

Some of the preferred repeat units I are listed below:

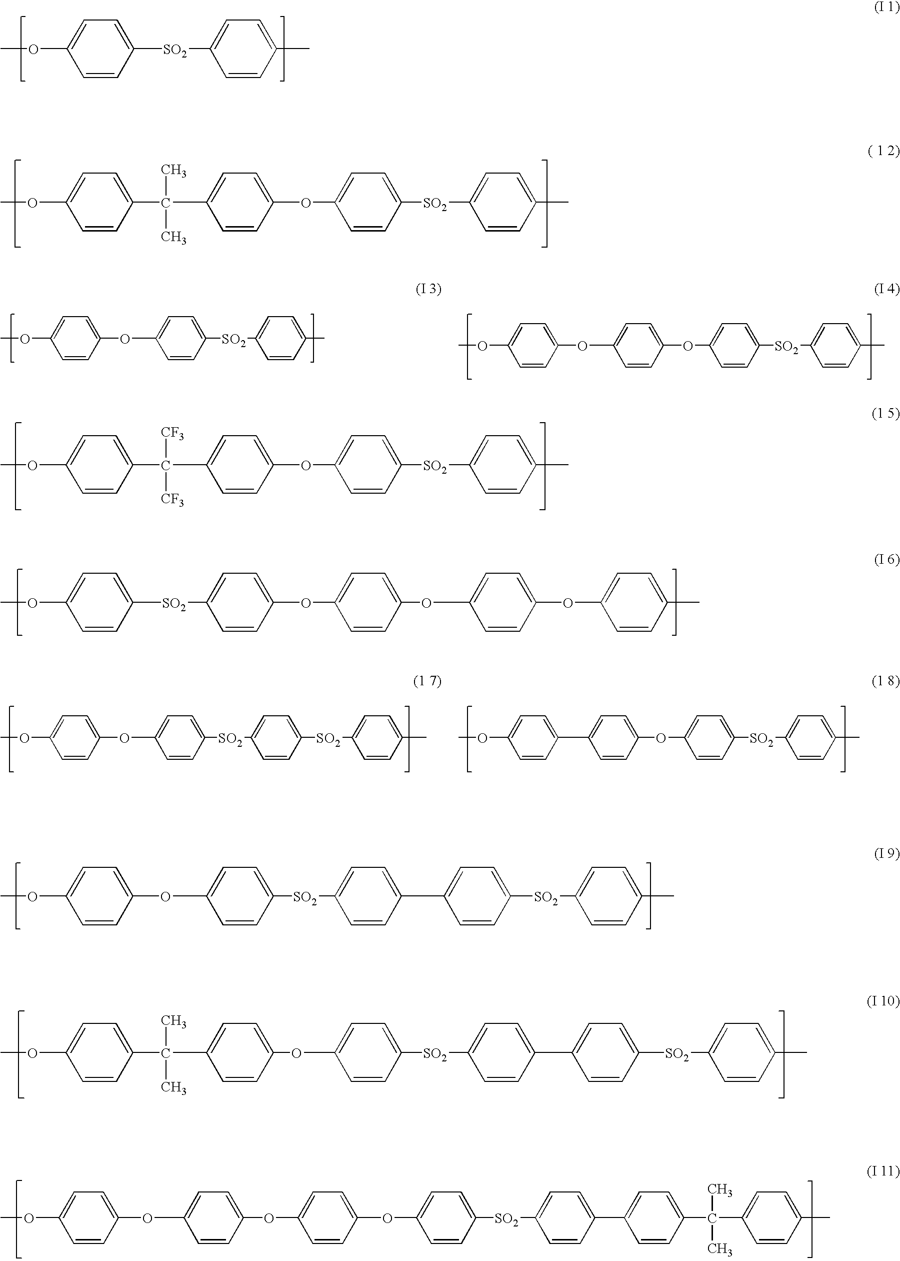

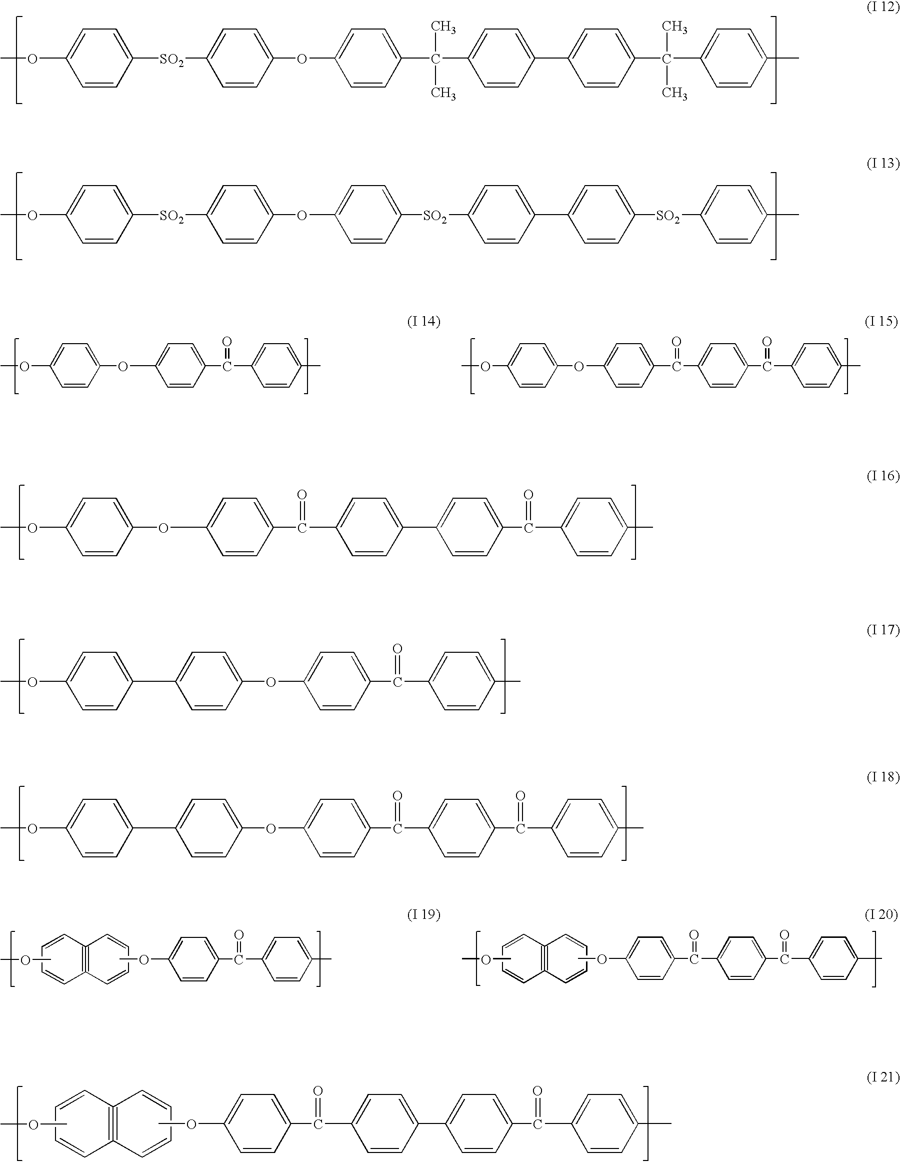

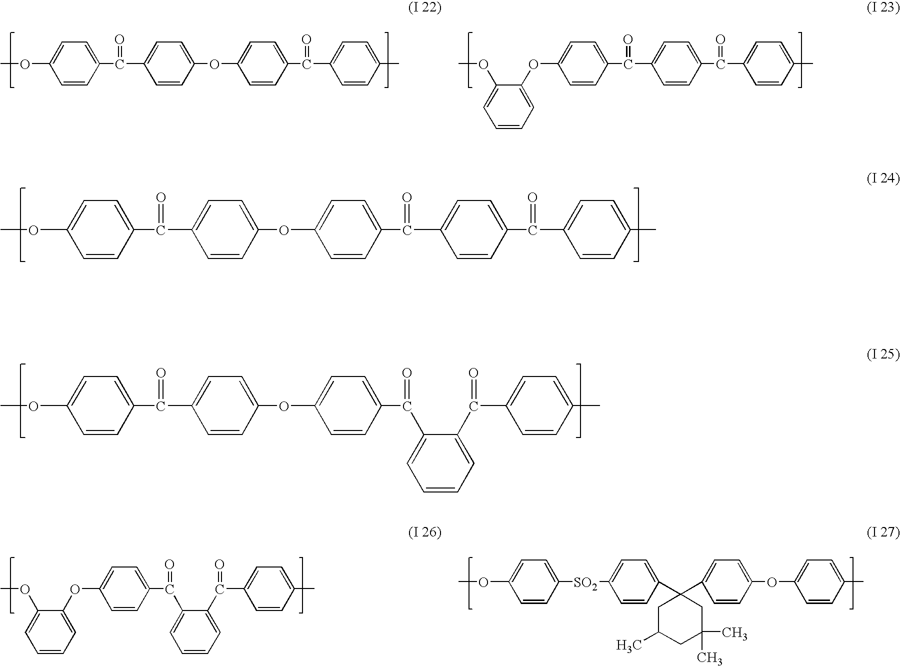

Very particular preference is given to polyarylene ethers which comprise (I₁), (I₂), (I₂₄), or (I₂₅) as repeat units. Among these are, for example, polyarylene ether sulfones having from 0 to 100 mol %, preferably from 5 to 95 mol %, of structural units (I₁) and from 0 to 100 mol %, preferably from 5 to 95 mol %, of structural units (I₂).

The polyarylene ethers can also be copolymers or block copolymers, in each of which there are polyarylene ether segments present and segments of other thermoplastic polymers, such as polyamides, polyesters, aromatic polycarbonates, polyester carbonates, polysiloxanes, polyimides, or polyetherimides. The molar masses of the blocks or of the graft arms in the copolymers are generally in the range from 1 000 to 30 000 g/mol. The blocks of different structure can have an alternating or random arrangement. The proportion by weight of the polyarylene ether segments in the copolymers or block copolymers is generally at least 3% by weight, preferably at least 10% by weight. The proportion by weight of the polyarylene ether sulfones or polyarylene ether ketones can be up to 97% by weight. Preference is given to copolymers or block copolymers whose proportion by weight of polyarylene ether segments is up to 90% by weight. Copolymers or block copolymers having from 20 to 80% by weight of polyarylene ether segments are particularly preferred.

The average molar masses Mr (number-average) of the polyarylene ethers are generally in a range from 10 000 to 60 000 g/mol, their viscosity numbers being from 30 to 150 ml/g. The viscosity numbers are measured as a function of solubility of the polyarylene ethers (A) or (B) either in 1% strength by weight N-methylpyrrolidone solution or in a mixture composed of phenol and o-dichlorobenzene, or in 96% strength sulfuric acid, in each case at 20° C. or, respectively, 25° C.

The polyarylene ethers are known per se or can be prepared by methods known per se.

For example, polyphenylene ethers can be prepared by oxidative coupling of phenols. Polyarylene ether sulfones or polyarylene ether ketones are produced, for example, via condensation of aromatic bishalogen compounds and of the alkali metal double salts of aromatic bisphenols. They can also by way of example be prepared via auto-condensation of alkali metal salts of aromatic halophenols in the presence of a catalyst.

The monomers are preferably polymerized in the melt or in an inert high-boiling point solvent. Among these are chlorobenzene, dichlorobenzene, xylene, and trichlorobenzene. Alongside these, other compounds that can be used are sulfones or sulfoxides, among which are especially dimethyl sulfone, diethyl sulfone, 1,1 -dioxotetrahydrothiophene (sulfolane), or diphenyl sulfone, dimethyl sulfoxide, or diethyl sulfoxide, preferably dimethyl sulphoxide. Among the preferred solvents are also N-alkylpyrrolidones, in particular N-methylpyrrolidone. It is also possible to use N-substituted amides, such as N,N-dimethylformamide or N,N-dimethylacetamide. It is also possible to use a mixture of different solvents.

Preferred process conditions for synthesis of polyarylene ether sulfones or of polyarylene ether ketones are described by way of example in EP-A-1 13 112 and 135 130.

The melting point of the preferred polyarylene ethers is generally at least 320° C. (polyarylene ether sulfones) and, respectively, at least 370° C. (polyarylene ether ketones).

According to the invention, the molding compositions can comprise polyarylene ether sulfones or polyarylene ether ketones which are obtainable via reaction of a polyarylene ether sulfone or polyarylene ether ketone with a reactive compound. The reactive compounds comprise, alongside a carbon-carbon double or carbon-carbon triple bond, one or more carbonyl, carboxylic acid, carboxylate, anhydride, imide, carboxylic ester, amino, hyroxy, epoxy, oxazoline, urethane, urea, lactam, or halobenzyl groups.

Examples of typical suitable compounds are maleic acid, methylmaleic acid, itaconic acid, tetrahydrophthalic acid, anhydrides and imides thereof, fumaric acid, the mono- and diesters of these acids, e.g. of C₁-C₁₈ alkanols, the mono- or diamides of these acids, such as N-phenylmaleimide, and maleic hydrazide.

It is preferable to use α,β-unsaturated dicarboxylic acids or their anhydrides, and diesters and monoesters of the general structure IV and V below.

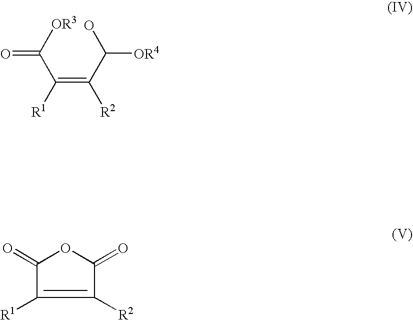

where

R¹, R², R³, and R⁴, independently of one another, can be hydrogen or else C₁-C₁₈-alkyl groups.

Particularly suitable compounds are maleic anhydride, fumaric acid, and itaconic acid.

The polymers and the reactive compound can, for example, be reacted with one another in an aromatic solvent. Chlorobenzene, o-dichlorobenzene, and N-methyl-pyrrolidone have proven to be particularly suitable solvents. A conventional free-radical initiator is generally used here. The reaction is generally conducted at from 75 to 150° C. The reaction product is obtained via precipitation with a conventional precipitant, such as low-molecular-weight alcohol and ketone, or via removal of the solvent (e.g. in a vented extruder or thin-film evaporator).

However, by way of example, the reactants can also be reacted at a temperature of from 270-350° C. in the melt in a mixing assembly operating continuously or batchwise (e.g. a single- or twin-screw extruder or a kneader).

The reactive compound here is preferably fed in liquid form, in particular within the kneading zone of a mixing assembly, to the melt of the polymer.

It is preferable to use modified polyarylene ether sulfones or modified polyarylene ether ketones, each of which has been obtained via reaction of from 80 to 99.9% by weight, in particular from 90 to 99% by weight, of the unmodified polyarylene ether sulfones or unmodified polyarylene ether ketones with from 0.1 to 20% by weight, in particular from 1 to 10% by weight, of the reactive compound.

Polyarylene ether sulfones grafted with from 0.1 to 1.5% by weight of maleic anhydride are particularly preferred as a component. Preference is given here to polyarylene ether sulfones comprising from 5 to 95 mol % of units 1, and from 5 to 95 mol % of units I₂.

Mention may be made in particular here of polyarylene ether sulfones having from 80 to 95 mol %, preferably from 85 to 95 mol %, of units of the formula I2 and I1 and correspondingly from 5 to 20 mol %, preferably from 5 to 15 mol %, of units of the formula I1 and, respectively, I2.

The free-radical initiators used can generally comprise the compounds described in the technical literature (e.g. J.K. Kochi, “Free Radicals”, J. Wiley, New York, 1973).

The amounts usually used of the free-radical initiators are from about 0.01 to about 1% by weight, based on the polyarylene ether sulfones or polyarylene ether ketones used. Mixtures of different free-radical initiators can, of course, also be used.

Appropriately modified polyphenylene ethers are known inter alia from WO 87/00540, and these can in particular be used in mixtures with polyamide.

The proportion by weight of thermoplastics is generally in the range from 10 to 99.9% by weight, preferably from 20 to 99.9% by weight, and in particular from 50 to 98% by weight.

The inventive molding compositions comprise, as component B), amounts of from 0.01 to 10% by weight, preferably from 0.03 to 8% by weight, in particular from 0.1 to 5% by weight, of a copolymer B) as defined in the introduction.

The process for preparation of the copolymer B) here takes place semicontinuously in a polymerization vessel, and the polymerization vessel here is intended to mean any of the vessels in which an aqueous emulsion polymerization can be carried out. Polymerization vessels here comprise by way of example in particular glass reactors, enameled steel reactors, or stainless steel reactors, the size of which can be from 0.5 l to 100 m³.

Monomers A that can be used inter alia are in particular ethylenically unsaturated monomers readily capable of free-radical polymerization, examples being ethylene, vinylaromatic monomers, such as styrene, α-methylstyrene, o-chlorostyrene, or vinyltoluenes, esters composed of vinyl alcohol and of monocarboxylic acids having from 1 to 18 carbon atoms, e.g. vinyl acetate, vinyl propionate, vinyl n-butyrate, vinyl laurate, and vinyl stearate, esters composed of α,β-monoethylenically unsaturated mono- and dicarboxylic acids preferably having from 3 to 6 carbon atoms, particular examples being acrylic acid, methacrylic acid, maleic acid, fumaric acid, and itaconic acid, with alkanols generally having from 1 to 12, preferably from 1 to 8, and in particular from 1 to 4, carbon atoms, e.g. particularly methyl, ethyl, n-butyl, isobutyl, and 2-ethylhexyl acrylates and the corresponding methacrylates, dimethyl maleate or di-n-butyl maleate, nitriles of α,β-monoethylenically unsaturated carboxylic acids, e.g. acrylonitrile, and also C₄₋₈ conjugated dienes, such as 1,3-butadiene and isoprene. The monomers mentioned generally form the main monomers, their combined proportion being ≧50% by weight, ≧80% by weight, or ≧90% by weight, based on the entire amount of the monomers A to be polymerized by the inventive process. Very generally, these monomers have only moderate to low solubility in water under standard conditions [20° C., 1 atm=1.013 bar (absolute)].

Further monomers A, which usually increase the internal strength of the filmed polymer matrix, normally have at least one hydroxy, N-methylol, or carbonyl group. Those of particular importance in this connection are the C₁-C₈-hydroxyalkyl acrylates and the corresponding methacrylates, e.g. n-hydroxyethyl, n-hydroxypropyl, or n-hydroxybutyl acrylate and the corresponding methacrylates, and also compounds such as diacetone acrylamide and acetylacetoxyethyl acrylate and the corresponding methacrylate. According to the invention, the amounts used of the abovementioned monomers for the polymerization process, based on the entire amount of the monomers A to be polymerized, are ≦5% by weight, often ≧0.1 and ≦3% by weight, and frequently ≧0.2 and ≦2% by weight.

Other monomers A that can be used are ethylenically unsaturated monomers comprising siloxane groups, e.g. the vinyltrialkoxysilanes, such as vinyltrimethoxysilane, alkylvinyldialkoxysilanes, acryloxyalkyltrialkoxysilanes, or methacryloxyalkyltri-alkoxysilanes, e.g. acryloxyethyltrimethoxysilane, methacryloxyethyltrimethoxysilane, acryloxypropyltrimethoxysilane, or methacryloxypropyltrimethoxysilane. The entire amounts used of these monomers are ≦5% by weight, frequently ≧0.01 and ≦3% by weight and often ≧0.05 and ≦1% by weight, based in each case on the entire amount of the monomers A.

Besides these, other monomers A that can be used are ethylenically unsaturated monomers AS which comprise at least one acid group and/or its corresponding anion, or ethylenically unsaturated monomers AK which comprise at least one amino, amido, ureido, or N-heterocyclic group and/or its N-protonated or N-alkylated ammonium derivatives. The amount of monomers AS and, respectively, monomers AK, based on the entire amount of the monomers A to be polymerized, is ≦10% by weight, often ≧0.1 and ≦7% by weight, and frequently ≧0.2 and ≦5% by weight.

Monomers AS used are ethylenically unsaturated monomers having at least one acid group. The acid group here can by way of example be a sulfonic acid group, sulfuric acid group, phosphoric acid group, and/or phosphonic acid group. Examples of these monomers AS are 4-styrenesulfonic acid, 2-methacryloxyethylsulfonic acid, vinylsulfonic acid, and vinylphosphonic acid, and also phosphoric monoesters of n-hydroxyalkyl acrylates and of n-hydroxyalkyl methacrylates, examples being the phosphoric monoester of hydroxyethyl acrylate, n-hydroxypropyl acrylate, n-hydroxybutyl acrylate and hydroxyethyl methacrylate, n-hydroxypropyl methacrylate, or n-hydroxybutyl methacrylate. However, according to the invention it is also possible to use the ammonium and alkali metal salts of the abovementioned ethylenically unsaturated monomers having at least one acid group. Sodium and potassium are particularly preferred as alkali metal. Examples here are the ammonium, sodium, and potassium salts of 4-styrenesulfonic acid, 2-methacryloxyethylsulfonic acid, vinylsulfonic acid, and vinylphosphonic acid, and also the mono- and diammonium, -sodium, and -potassium salts of the phosphoric monoester of hydroxyethyl acrylate, n-hydroxypropyl acrylate, n-hydroxybutyl acrylate and hydroxyethyl methacrylate, n-hydroxypropyl methacrylate, or n-hydroxybutyl methacrylate.

It is preferable to use 4-styrenesulfonic acid, 2-methacryloxyethylsulfonic acid, vinylsulfonic acid, and vinylphosphonic acid as monomers AS.

The monomers AK used comprise ethylenically unsaturated monomers which comprise at least one amino, amido, ureido, or N-heterocyclic group, and/or the N-protonated or N-alkylated ammonium derivatives thereof.

Examples of monomers AK which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)-ethyl methacrylate (by way of example commercially available in the form of Norsocryl® TBAEMA from Elf Atochem), 2-(N,N-dimethylamino)ethyl acrylate (by way of example commercially available in the form of Norsocryl® ADAME from Elf Atochem), 2-(N,N-dimethylamino)ethyl methacrylate (by way of example commercially available in the form of Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)-propyl methacrylate, 3-(N-isopropylamino)propyl acrylate, 3-(N-isopropylamino)propyl methacrylate, 3-(N-tert-butylamino)propyl acrylate, 3-(N-tert-butylamino) propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-di-isopropylamino)propylacrylate, and 3-(N,N-diisopropylamino)-propyl methacrylate.

Examples of monomers AK which comprise at least one amido group are N-methyl-acrylamide, N-methylmethacrylamide, N-ethylacrylamide, N-ethylmethacrylamide, N-n-propylacrylamide, N-n-propylmethacrylamide, N-isopropylacrylamide, N-isopropyl-methacrylamide, N-tert-butylacrylamide, N-tert-butylmethacrylamide N,N-dimethyl-acrylamide N,N-dimethylmethacrylamide, N,N-diethylacrylamide, N,N-diethylmeth-acrylamide, N,N-di-n-propylacrylamide, N,N-di-n-propylmethacrylamide, N,N-diiso-propylacrylamide, N,N-diisopropylmethacrylamide, N,N-di-n-butylacrylamide, N,N-di-n-butylmethacrylamide, N-(3-N′,N′-dimethylaminopropyl)methacrylam ide, diacetoneacrylamide, N,N′-methylenebisacrylamide, N-(diphenylmethyl)acrylamide, N-cyclohexylacrylamide, and also N-vinylpyrrolidone and N-vinylcaprolactam.

Examples of monomers AK which comprise at least one ureido group are N,N′-divinylethyleneurea and 2-(1-imidazolin-2-onyl)ethyl methacrylate (by way of example commercially available in the form of Norsocryl® 100 from Elf Atochem).

Examples of monomers AK which comprise at least one N-heterocyclic group are 2-vinylpyridine, 4-vinylpyridine, 1-vinylimidazole, 2-vinylimidazole and N-vinylcarbazole.

It is preferable to use the following compounds as monomers AK: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)-ethyl methacrylate, and 2-(1-imidazolin-2-onyl)ethyl methacrylate.

As a function of the pH value of the aqueous reaction medium, a portion or the entire amount of the abovementioned monomers AK comprising nitrogen can be present in the N-protonated quaternary ammonium form.

Examples that may be mentioned of monomers AK which have a quaternary alkyl ammonium structure at the nitrogen are 2-(N,N,N-trimethylammonium)ethylacrylate chloride (by way of example commercially available in the form of Norsocryl® ADAMQUAT MC 80 from Elf Atochem), 2-(N,N,N-trimethylammonium)ethyl methacrylate chloride (by way of example commercially available in the form of Norsocryl® MADQUAT MC 75 from Elf Atochem), 2-(N-methyl-N,N-diethylammonium)-ethyl acrylate chloride, 2-(N-methyl-N,N-diethylammonium)ethyl methacrylate chloride, 2-(N-methyl-N,N-dipropylammonium)ethyl acrylate chloride, 2-(N-methyl-N,N-dipropylammonium)ethyl methacrylate, 2-(N-benzyl-N,N-dimethylammonium)ethyl acrylate chloride (by way of example commercially available in the form of Norsocryl® ADAMQUAT BZ 80 from Elf Atochem), 2-(N-Benzyl-N,N-dimethylammonium)ethyl methacrylate chloride (by way of example commercially available in the form of Norsocryl® MADQUAT BZ 75 from Elf Atochem), 2-(N-benzyl-N,N-diethylammonium)-ethyl acrylate chloride, 2-(N-benzyl-N,N-diethylammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethylammonium)propyl acrylate chloride, 3-(N,N,N-trimethylammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)propyl acrylate chloride, 3-(N-methyl-N,N-dipropyl-ammonium)propyl methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethylammonium)-propyl acrylate chloride, 3-(N-benzyl-N,N-diethylammonium)propyl methacrylate chloride, 3-(N-benzyl-N,N-dipropylammonium)propyl acrylate chloride, and 3-(N-benzyl-N,N-dipropylammonium)propyl methacrylate chloride. It is, of course, also possible to use the corresponding bromides and sulfates instead of the chlorides mentioned.

It is preferable to use 2-(N,N,N-trimethylammonium)ethyl acrylate chloride, 2-(N,N,N-trimethylammonium)ethyl methacrylate chloride, 2-(N-benzyl-N,N-dimethylammonium)-ethyl acrylate chloride, and 2-(N-benzyl-N,N-dimethylammonium)ethyl methacrylate chloride.

It is, of course, also possible to use a mixture of the abovementioned ethylenically unsaturated monomers A.

The entire amount of the monomers A is from 70 to 99.5% by weight, advantageously from 80 to 99% by weight, particularly advantageously from 90 to 98% by weight, based in each case on the entire amount of monomers.

According to the invention, it is possible, if appropriate, to use a portion of the monomers A in the polymerization vessel as initial charge and to feed the entire amount or the remaining residual amount, if appropriate, of monomers A to the polymerization vessel under polymerization conditions batchwise in a plurality of portions or continuously with constant or changing flow rates. It is advantageous to use ≦30% by weight, and particularly advantageous to use ≦10% by weight, of the monomers A in the polymerization vessel as an initial charge, and to feed the entire amount or the remaining residual amount, of monomers A to the polymerization vessel continuously with constant or changing flow rates.

Monomers B used comprise compounds having at least two ethylenically unsaturated groups capable of free-radical copolymerization. Examples here are monomers having at least two vinyl radicals, monomers having at least two vinylidene radicals, and also monomers having at least two alkenyl radicals. Those particularly advantageous here are the diesters of dihydric alcohols with α,β-monoethylenically unsaturated monocarboxylic acids, among which preference is given to acrylic and methacrylic acid. Examples of these monomers having two unconjugated ethylenically unsaturated double bonds are alkylene glycol diacrylates and the corresponding dimethacrylates, e.g. ethylene glycol diacrylate, propylene 1,2-glycol diacrylate, propylene 1,3-glycol diacrylate, butylene 1,3-glycol diacrylate, butylene 1,4-glycol diacrylate, and ethylene glycol dimethacrylate, propylene 1,2-glycol dimethacrylate, propylene 1,3-glycol dimethacrylate, butylene 1,3-glycol dimethacrylate, butylene 1,4-glycol dimethacrylate, and also o-, m-, and/or p-divinylbenzene, vinyl methacrylate, vinyl acrylate, allyl methacrylate, allyl acrylate, diallyl maleate, diallyl fumarate, diallyl phthalate, methylenebisacrylamide, cyclopentadienyl acrylate, triallyl cyanurate, or triallyl isocyanurate.

It is, of course, also possible to use a mixture of the abovementioned monomers B.

It is advantageous to use o-/m-/p-divinylbenzene, butylene 1,4-glycol diacrylate, vinyl acrylate, vinyl methacrylate, allyl acrylate, and/or allyl methacrylate as monomers B.

The entire amount of the monomers B is from 0.5 to 30% by weight, advantageously from 1 to 20% by weight, and particularly advantageously from 2 to 10% by weight, based in each case on the entire amount of monomers.

According to the invention, it is possible, if appropriate, that a portion of the monomers B is used as initial charge in the polymerization vessel and the entire amount or the remaining residual amount, if appropriate, of monomers B is fed to the polymerization vessel under polymerization conditions, batchwise in a plurality of portions or continuously with constant or changing flow rates. It is advantageous to use ≦10% by weight, and particularly advantageous to use ≦5% by weight of the monomers B in the polymerization vessel as an initial charge, and to feed the entire amount or the remaining residual amount, of monomers B to the polymerization vessel. Monomers C used comprise α,βmonoethylenically unsaturated mono- or dicarboxylic acids having from 3 to 6 carbon atoms, and/or amides of these. Examples here are acrylic acid, methacrylic acid, maleic acid, fumaric acid, itaconic acid, crotonic acid, and also the corresponding amides of these. However, according to the invention it is also possible to use the ammonium and alkali metal salts of the abovementioned ethylenically unsaturated mono- or dicarboxylic acids. Sodium and potassium are particularly preferred alkali metals. Examples here are the ammonium, sodium, and potassium salts of acrylic acid, methacrylic acid, maleic acid, fumaric acid, itaconic acid, and crotonic acid.

It is, of course, also possible to use a mixture of the abovementioned monomers C.

It is advantageous to use acrylic acid, methacrylic acid, itaconic acid, acrylamide, and/or methacrylamide as monomers C.

The entire amount of the monomers C is generally ≦5% by weight, often ≧0.1 and ≦3% by weight, and frequently ≧0.2 and ≦2% by weight, based in each case on the entire amount of monomers.

According to the invention, it is possible, if appropriate, to use a portion of the monomers C in the polymerization vessel as initial charge and to feed the entire amount or the remaining residual amount, if appropriate, of monomers C to the polymerization vessel under polymerization conditions batchwise in a plurality of portions or continuously with constant or changing flow rates. It is advantageous to use ≦30% by weight, and particularly advantageous to use <10% by weight, of the monomers C in the polymerization vessel as an initial charge, and to feed the entire amount or the remaining residual amount of monomers C to the polymerization vessel continuously with constant or changing flow rates.

The selection of the monomers A to C is particularly advantageously such that the solubility of ≧95% by weight and particularly advantageously ≧97% by weight, of all of the monomers at 20° C. and 1 atm (absolute) in deionized water is ≦10% by weight and in particular ≦5% by weight.

The selection of the nature and amount of the monomers A and of the monomers C would be advantageously such that the glass transition temperature of a copolymer composed only of these monomers would be ≧40° C., advantageously ≧70° C., and particularly advantageously ≧90° C.

The glass transition temperature is usually determined to DIN 53 765 (differential scanning calorimetry, 20 K/min, midpoint measurement).

According to Fox (T.G. Fox, Bull. Am. Phys. Soc. 1956 [Ser. II] 1, page 123, and according to Ullmann's Encyclopadie der technischen Chemie [Ullmann's Encyclopedia of Industrial Chemistry], vol.19, page 18, 4th edition, Verlag Chemie, Weinheim, 1980) a good approximation to the glass transition temperature T_{g} of copolymers having at most weak crosslinking is given by:

1/T_{g}=x¹/T_{g}¹+x²/T_{g}²+. . . xⁿ/T_{g}ⁿ,

where x¹, x², . . . xⁿ are the mass fractions of the monomers 1, 2, . . . n, and T_{g}¹, T_{g}², . . . T_{g}ⁿ are the glass transition temperatures, in degrees Kelvin of the respective polymers composed only of one of the monomers 1, 2, . . . n. The T_{g} values for the homopolymers of most monomers are known and are listed by way of example in Ullmann's Encyclopedia of Industrial Chemistry, 5th edn., vol. A21, pagel69, Verlag Chemie, Weinheim, 1992; examples of further sources for glass transition temperatures of homopolymers are: J. Brandrup, E. H. Immergut, Polymer Handbook, 1st ed., J. Wiley, New York, 1966; 2nd ed. J. Wiley, New York, 1975 and 3rd ed. J. Wiley, New York, 1989.

The present inventive process uses water, preferably drinking water, and particularly preferably deionized water, its entire amount being judged so that it is from 30 to 90% by weight and advantageously from 50 to 80% by weight, in each case based on the aqueous copolymer dispersion obtainable via the inventive process.

The invention permits, if appropriate, use of a portion of or the entire amount of water in the polymerization vessel as initial charge. However, it is also possible to feed the entire amount, or the remaining residual amount, if appropriate, of water together with the monomers A, B and/or C, in particular in the form of an aqueous monomer emulsion. It is advantageous to use a small portion of water in the polymerization vessel as initial charge and to feed a relatively large portion of water in the form of an aqueous monomer emulsion under polymerization conditions.

For the purposes of the inventive process, concomitant use is made of dispersing agents, which keep not only the monomer droplets but also the copolymer particles formed in dispersion in the aqueous phase, and thus ensure that the aqueous copolymer dispersion produced is stable. These can be either the protective colloids usually used for the conduct of free-radical aqueous emulsion polymerizations, or else emulsifiers.

Examples of suitable protective colloids are polyvinyl alcohols, cellulose derivatives, or copolymers comprising vinylpyrrolidone. Houben-Weyl, Methoden der organischen Chemie [Methods of organic chemistry], volume XIV/1, Makromolekulare Stoffe [Macromolecular substances], pages 411 to 420, Georg-Thieme-Verlag, Stuttgart, 1961 gives a detailed description of further suitable protective colloids.

It is, of course, also possible to use a mixture composed of emulsifiers and/or of protective colloids. The dispersing agents used frequently comprise exclusively emulsifiers, the relative molar masses of these being usually below 1000 g/mol, unlike those of the protective colloids. They can be either anionic, cationic, or non-ionic. If a mixture of surfactant substances is used, the individual components must, of course, be compatible with one another, and in the case of doubt this can be checked by using a few preliminary experiments. Anionic emulsifiers are generally compatible with one another and with nonionic emulsifiers. The same also applies to cationic emulsifiers, whereas anionic and cationic emulsifiers are mostly not compatible with one another.

Examples of familiar emulsifiers are ethoxylated mono-, di-, and trialkylphenols (EO number: from 3 to 50, alkyl radical: C₄ to C₁₂), ethoxylated fatty alcohols (EO number: from 3 to 50; alkyl radical: C₈ to C₃₆), and also the alkali metal and ammonium salts of alkyl sulfate (alkyl radical: C₈ to C₁₂), of sulfuric half-esters of ethoxylated alkanols (EO number: from 4 to 30, alkyl radical: C₁₂ to C₁₈), and of ethoxylated alkyl phenols (EO number: from 3 to 50, alkyl radical: C₄ to C₁₂), of alkylsulfonic acids (alkyl radical: C₁₂ to C₁₈), and of alkylarylsulfic acids (alkyl radical: C₉ to C₁₈). Houben-Weyl, Methoden der organischen Chemie [Methods of organic chemistry], volume XIV/1, Makromolekulare Stoffe [Macromolecular substances], pages 192 to 208, Georg-Thieme-Verlag, Stuttgart, 1961 gives further suitable emulsifiers.

Compounds of the general formula I have moreover proven suitable as surfactant substances

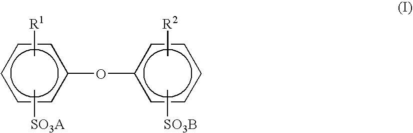

in which R¹ and R² can be C₄-C₂₄-alkyl and one of the radicals R¹ or R² can also be hydrogen, and A and B can be alkali metal ions and/or ammonium ions. R¹ and R² in the general formula I are preferably linear or branched alkyl radicals having from 6 to 18 carbon atoms, in particular having 6, 12, or 16 carbon atoms, or hydrogen atoms, but R¹ and R² are not simultaneously hydrogen atoms. A and B are preferably sodium, potassium, or ammonium ions, particularly preferably sodium ions. Particularly advantageous compounds I are those in which A and B are sodium ions, R¹ is a branched alkyl radical having 12 carbon atoms, and R² is a hydrogen atom or R¹. Industrial mixtures are often used, having a proportion of from 50 to 90% by weight of the monoalkylated product, for example Dowfax® 2A1 (trademark of Dow Chemical Company). The compounds I are well known, e.g. from U.S. Pat. No. 4,269,749, and are commercially available.

The inventive process preferably uses nonionic and/or anionic emulsifiers. However, it is also possible to use cationic emulsifiers. It is particularly preferable to use anionic emulsifiers, such as alkylarylsulfonic acids, alkyl sulfates, sulfuric half-esters of ethoxylated alkanols, and/or appropriate alkali metal salts of these.

The amount of dispersing agent used is generally ≧0.1 and ≦15% by weight, and preferably ≧0.5 to ≦5% by weight, based in each case on the entire amount of monomer.

It is possible according to the invention, if appropriate, to use a portion of, or the entire amount of, dispersing agent in the polymerization vessel as initial charge. However, it is also possible to feed the entire amount or the remaining residual amount, if appropriate, of dispersing agent together with the monomers A, B and/or C, in particular in the form of an aqueous monomer emulsion, under polymerization conditions.

The free-radical-initiated aqueous emulsion polymerization is initiated by means of a free-radical polymerization initiator (free-radical initiator). This can in principle be either peroxides or else azo compounds. It is, of course, also possible to use redox initiator systems. Peroxides used can in principle be inorganic peroxides, such as hydrogen peroxide, or peroxodisulfates, such as the mono- or di(alkali metal) or ammonium salts of peroxodisulfuric acid, e.g. its mono- and disodium, -potassium, or ammonium salts, or organic peroxides, such as alkyl hydroperoxides, e.g. tert-butyl, p-menthyl, or cumyl hydroperoxide, or else dialkyl or diaryl peroxides, such as di-tert-butyl or dicumyl peroxide. The azo compound used in essence comprises 2,2′-azobis(isobutyronitrile), 2,2′-azobis(2,4-dimethylvaleronitrile), and 2,2′-azobis(amidinopropyl) dihydrochloride (AIBA, corresponding to V-50 from Wako Chemicals). Oxidants that can be used for redox initiator systems are in essence the abovementioned peroxides. Corresponding reducing agents used can comprise sulfur compounds with low oxidation state, e.g. alkali metal sulfites, such as potassium sulfite and/or sodium sulfite, alkali metal hydrogen sulfites, such as potassium hydrogen sulfite and/or sodium hydrogen sulfite, alkali metal metabisulfites, such as potassium metabisulfite and/or sodium metabisulfite, formaldehyde sulfoxylates, such as potassium formaldehyde sulfoxylate and/or sodium formaldehyde sulfoxylate, alkali metal salts, specifically the potassium and/or sodium salts of aliphatic sulfinic acids, and alkali metal hydrogensulfides, such as potassium hydrogensulfide and/or sodium hydrogensulfide, salts of polyvalent metals, e.g. ferrous sulfate, ferrous ammonium sulfate, ferrous phosphate, enediols, such as dihydroxymaleic acid, benzoin, and/or ascorbic acid, or else reducing saccharides, such as sorbose, glucose, fructose, and/or dihydroxyacetone. The amount of the free-radical initiator used, based on the entire amount of monomer, is generally from 0.01 to 5% by weight, preferably from 0.1 to 3% by weight, and particularly preferably from 0.2 to 1.5% by weight.

According to the invention, it is possible, if appropriate, to use a portion of, or the entire amount of, free-radical initiator in the polymerization vessel as initial charge. However, it is also possible to feed the entire amount or the remaining residual amount, if appropriate, of free-radical initiator to the polymerization vessel under polymerization conditions.

According to the invention, it is also possible to use other optional auxiliaries known to the person skilled in the art, examples being those known as thickeners, antifoams, neutralizing agents, preservatives, free-radical chain-transfer compounds, and/or complexing agents.

The substances known as thickeners or rheology additives are often used as a constituent of the formulation, in order to optimize the rheology of the inventively obtainable aqueous copolymer dispersions during preparation, handling, storage, and application. A wide variety of thickeners is known to the person skilled in the art, examples being organic thickeners, such as xanthane thickeners, guar thickeners (polysaccharides), carboxymethylcellulose, hydroxyethylcellulose, methylcellulose, hydroxypropylmethylcellulose, ethylhydroxyethylcellulose (cellulose derivatives), alkali-swellable dispersions (acrylate thickeners), or hydrophobically modified, polyether-based polyurethanes (polyurethane thickeners), or inorganic thickeners, such as bentonite, hectorite, smectite, attapulgite (bentone), or else titanates or zirconates (metal organyl compounds).

Substances known as antifoams are used in order to avoid foaming during preparation, handling, storage, and application of the inventively obtainable aqueous copolymer dispersions. The antifoams are familiar to the person skilled in the art. These are in essence mineral oil antifoams and silicone oil antifoams. The selection and addition of antifoams, especially of the high-activity antifoams comprising silicone, generally requires very great care, since they can lead to surface defects (craters, depressions, etc.) in the coating. A significant factor is that a further increase in antifoam action can be achieved via addition of very fine hydrophobic particles, such as hydrophobic silica or wax particles, to the antifoam liquid.

Acids or bases familiar as neutralizing agents for the person skilled in the art can, if required, be used to adjust the pH of the inventively obtainable aqueous polymer dispersions.

Preservatives or biocides familiar to the person skilled in the art are frequently used in order to avoid infestation of the inventively obtainable aqueous copolymer dispersions by microorganisms, such as bacteria, (mold) fungi, or yeasts, during preparation, handling, storage, and application. Formaldehyde or agents which cleave to give formaldehyde are often used here, as also are active ingredient combinations composed of methyl- and chloroisothiazolinones, or of benzoisothiazolinones.

Free-radical chain-transfer compounds can also optionally be used, in order to reduce or control the molecular weight of the copolymers obtainable via the polymerization reaction, alongside the abovementioned components in the inventive process for preparation of the aqueous copolymer dispersions. The substances used here are in essence aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary, or tertiary aliphatic thiols, e.g. ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and also any of the further sulfur compounds described in Polymer Handbook 3rd edition, 1989, J. Brandrup and E. H. Immergut, John Wiley & Sons, section II, pages 133 to 141, or else aliphatic and/or aromatic aldehydes, such as acetaldehyde, propionaldehyde and/or benzaldehyde, unsaturated fatty acids, such as oleic acid, dienes having non-conjugated double bonds, such as divinyl methane or vinyl cyclohexane, or hydrocarbons having readily abstractable hydrogen acids, such as toluene. It is advantageous to use tert-dodecyl mercaptan, 2,4-diphenyl-4-methyl-1 -pentene, or else terpinols (see, for example, DE-A 10046930 or DE-A 10148511).

The entire amount of the further optional auxiliaries, based on the entire amount of monomers, is generally ≦10% by weight, ≦5% by weight, often ≦3% by weight, and frequently ≦2% by weight.

According to the invention, it is possible, if appropriate, to use portions of, or entire amounts of, further optional auxiliaries in the polymerization vessel as initial charge. However, it is also possible to feed entire amounts, or, if appropriate, the remaining residual amounts, of further optional auxiliaries under polymerization conditions, if appropriate in the form of a constituent of the monomer mixture or of the aqueous monomer emulsion comprising this mixture.

The inventive free-radical-initiated aqueous emulsion polymerization can optionally also be carried out in the presence of a polymer seed, for example in the presence of, in each case based on the total amount of monomers, from 0.01 to 10% by weight, frequently from 0.01 to 5% by weight, and often from 0.04 to 3.5% by weight, of a polymer seed.

A polymer seed is used in particular when the size of the polymer particles to be prepared by means of aqueous free-radical emulsion polymerization is to be set in a controlled manner (in which connection see by way of example U.S. Pat. No. 2,520,959 and U.S. Pat. No. 3,397,165).

The particular polymer seed particles used have a narrow particle size distribution and with weight-average diameter D_{w}≦100 nm, frequently ≧5 nm to ≦50 nm, and often ≧15 nm to ≦35 nm. The method for determining weight-average particle diameter is known to the person skilled in the art and by way of example uses the analytical ultracentrifuge method. In this specification, weight-average particle diameter means the weight-average D_{w50} value determined by the analytical ultracentrifuge method (cf. in this connection S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147-175).

For the purposes of this specification, narrow particle size distribution means that the ratio of the weight-average particle diameter D_{w50} to the number-average particle diameter D_{N50} [D_{w50}/D_{N50}] is ≦2.0, preferably ≦1.5, and particularly preferably ≦1.2 or ≦1.1, determined by the analytical ultracentrifuge method.

The form in which the polymer seed is used is usually that of an aqueous polymer dispersion. In this case, the abovementioned quantitative data are based on the polymer solids content of the aqueous polymer dispersion; they are therefore stated in terms of parts by weight of polymer seed solids, based on the total amount of monomer.

If a polymer seed is used, it is advantageous to use a foreign polymer seed. Unlike in what is known as in-situ polymer seed, which is prepared prior to the start of the actual emulsion polymerization in the reaction vessel, and whose monomeric constitution is the same as that of the polymer prepared via the subsequent free-radical-initiated aqueous emulsion polymerization, a foreign polymer seed is a polymer seed which has been prepared in a separate reaction step and whose monomeric constitution differs from that of the polymer prepared via the free-radical-initiated aqueous emulsion polymerization. This simply means that different monomers or monomer mixtures with different constitution are used for preparation of the foreign polymer seed and for preparation of the aqueous polymer dispersion. Preparation of a foreign polymer seed is familiar to the person skilled in the art, and usually proceeds by using a relatively small amount of monomers and a relatively large amount of emulsifiers as initial charge in a reaction vessel and adding a sufficient amount of polymerization initiator at reaction temperature.

According to the invention, it is preferable to use a foreign polymer seed whose glass transition temperature is ≧50° C., frequently ≧60° C. or ≧70° C., and often ≧80° C. or ≧90° C. Particular preference is given to a polystyrene polymer seed or a polymethyl methacrylate polymer seed.

According to the invention, it is possible, if appropriate, to use a portion of, or the entire amount of, foreign polymer seed as further optional auxiliary in the polymerization vessel as initial charge. However, it is also possible to feed the entire amount or, if appropriate, the remaining residual amounts, of foreign polymer seed, under polymerization conditions.

Polymerization conditions are the temperatures and pressures at which the free-radical-initiated aqueous emulsion polymerization proceeds with sufficient polymerization rate. However, this in particular depends on the free-radical initiator used. The selection of the nature and amount of the free-radical initiator, of the polymerization temperature, and of the polymerization pressure is preferably such that the half-lifetime of the free-radical initiator is ≦3 hours, particularly advantageously ≦1 hour, and very particularly advantageously ≦30 minutes.

As a function of the free-radical initiator selected, the reaction temperature for the inventive free-radical aqueous emulsion polymerization can be the entire range from 0 to 170° C. Temperatures of from 50 to 150° C., in particular from 60 to 130° C., and advantageously from 70 to 120° C., are generally used here. The inventive free-radical aqueous emulsion polymerization can be carried out at a pressure smaller than, equal to, or greater than 1 atm, and the polymerization temperature can therefore exceed 100° C. and can be up to 170° C. It is preferable to polymerize at an elevated pressure in the presence of volatile monomers, such as ethylene, butadiene, or vinyl chloride. The pressure here can be 1.2, 1.5, 2, 5,10, or 15 bar (absolute) or even higher. If emulsion polymerization reactions are carried out at subatmospheric pressure, the pressures set are 950 mbar, frequently 900 mbar, and often 850 mbar (absolute). The inventive free-radical aqueous emulsion polymerization is advantageously carried out at an elevated pressure under an inert gas, such as nitrogen or argon.

The method for the inventive process is generally such that a portion of the deionized water, of the dispersing agent, and also, if appropriate, a portion of the monomers A, B, and/or C, and of the free-radical initiator are used as initial charge in the polymerization vessel at from 20 to 25° C. (room temperature) under an inert gas, and then the initial charge mixture is heated, with stirring, to the appropriate polymerization temperature, and then the residual amounts of deionized water and dispersing agent, and also the entire amounts, or, if appropriate, the remaining residual amounts, of monomers A, B, and/or C, and also free-radical initiator, are fed. Addition of the monomers A, B, and/or C, and of the free-radical initiator, and also of the other components here, can take place batchwise in a plurality of portions, or else continuously with constant or changing flow rates.

In another preferred embodiment, the monomers A to C are added in the form of two monomer emulsions, where the first monomer emulsion (monomer emulsion 1) comprises ≧60% by weight of the entire amount of monomer, but ≦40% by weight of the entire amount of the monomers B, while the second monomer emulsion (monomer emulsion 2) comprises ≦40% by weight of the entire amount of monomers, but ≧60% by weight of the entire amount of the monomers B. This method for the inventive process is such that firstly monomer emulsion 1 and then monomer emulsion 2 are introduced into the polymerization vessel under polymerization conditions. According to the invention, it is possible here, if appropriate, that a portion of monomer emulsion 1 is used as initial charge in the polymerization vessel, and the entire amount, or, if appropriate, the remaining residual amount, of monomer emulsion 1 is added to the polymerization vessel under polymerization conditions, batchwise in a plurality of portions, or continuously with constant or changing flow rates. Monomer emulsion 2 is then fed to the polymerization vessel under polymerization conditions, batchwise in a plurality of portions or continuously with constant or changing flow rates. Addition of monomer emulsions 1 and 2 preferably takes place continuously with constant flow rates.

The selection of the reaction conditions and the conduct of the reaction are advantageously such that, after initiation of the free-radical polymerization reaction, the monomers A to C and the free-radical initiator are introduced into the polymerization mixture in the polymerization vessel in such a way that monomer conversion at every juncture is ≧80% by weight, advantageously ≧90% by weight, and particularly advantageously ≧95% by weight, based on the entire amount of the monomers introduced into the polymerization mixture at this juncture, and this can readily be checked via reaction-calorimetry measurements familiar to the person skilled in the art.

In principle, it is also possible that small amounts (≦10% by weight, based on the entire amount of water) of water-soluble organic solvents are used in the inventive process, examples being methanol, ethanol, isopropanol, butanols, pentanols, and also acetone, etc. However, it is preferable that the inventive process is carried out in the absence of such solvents.

The conduct of the reaction of the inventive process is advantageously such that ≧60% by weight and ≦95% by weight, preferably ≧60% by weight and ≦90% by weight, and particularly preferably ≧70% by weight and ≦90% by weight, of the entire amount of monomers B are fed to the polymerization mixture under polymerization conditions after ≧70% by weight, preferably ≧75% by weight, and particularly preferably ≧80% by weight, of the entire amount of monomers have been fed to the polymerization mixture under polymerization conditions.

The copolymer solids content of the aqueous copolymer dispersions obtained by the inventive process is usually ≧10 and ≦70% by weight, frequently ≧20 and ≦65% by weight, and often ≧40 and ≦60% by weight, in each case based on the aqueous copolymer dispersion. The number-average particle diameter (cumulant z average) determined by quasi-elastic light scattering (ISO standard 13 321) is generally from 10 to 2000 nm, frequently from 20 to 300 nm, and often from 30 to 200 nm.

In the inventively obtained aqueous copolymer dispersions it is, of course, possible to reduce the remaining residual contents of unconverted monomers A to C, and also of other low-boiling-point compounds via chemical and/or physical methods familiar to the person skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586, and 19847115].

The corresponding copolymer powders are moreover readily obtainable from the inventive aqueous copolymer dispersions (for example by freeze drying or spray drying). The inventive aqueous polymer dispersions are particularly suitable here for spray drying and exhibit high powder yields together with little tendency toward caking, even without further spraying aids.

The inventive molding compositions can comprise, as a further constituent, from 0 to 70% by weight, preferably up to 50% by weight, in particular up to 40% by weight, of further additives C).

Preferred fibrous reinforcing materials are amounts of up to 35% by weight, preferably from 15 to 35% by weight, of carbon fibers, potassium titanate whiskers, aramid fibers, and particularly preferably glass fibers. If glass fibers are used, these may have been equipped with a size and with a coupling agent for better compatibility, for example with the thermoplastic polyamide (A). The diameter of the glass fibers used is generally in the range from 6 to 20 μm.

The form in which these glass fibers are incorporated can either be that of short glass fibers or else that of continuous-filament strands (rovings). The average length of the glass fibers in the finished injection molding is preferably in the range from 0.08 to 0.5 mm.

Suitable particulate fillers are amorphous silica, magnesium carbonate (chalk), kaolin (in particular calcined kaolin), powdered quartz, mica, talc, feldspar, and in particular calcium silicates, such as wollastonite.

Examples of preferred combinations of fillers are 20% by weight of glass fibers with from 10 to 15% by weight of wollastonite and 15% by weight of glass fibers with 15% by weight of wollastonite.

Other additives C) by way of example are amounts of up to 30% by weight, preferably from 1 to 40% by weight, in particular from 10 to 15% by weight, of elastomeric polymers (also often termed impact modifiers, elastomers, or rubbers).

These are very generally copolymers which are preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these which may be mentioned are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formula I, II, III or IV

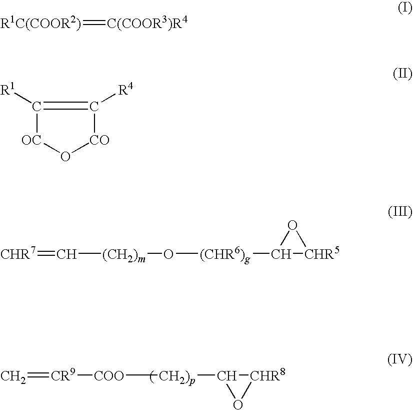

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of

from 50 to 98.g % by weight, in particular from 55 to 95% by weight, of ethylene,

from 0.1 to 40% by weight, in particular from 0.3 to 20% by weight, of glycidyl acrylate and/or glycidyl methacrylate, (meth)acrylic acid and/or maleic anhydride, and

from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion polymerization”. The emulsifiers and catalysts which can be used are known per se.

In principle it is possible to use homogeneously structured elastomers or else those with a shell structure. The shell-type structure is determined by the sequence of addition of the individual monomers; the morphology of the polymers is also affected by this sequence of addition.

Monomers which may be mentioned here, merely in a representative capacity, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have two or more shells composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

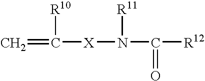

where:

R¹⁰ is hydrogen or a C₁-C₄-alkyl group,

R¹¹ is hydrogen or a C₁-C₈-alkyl group or an aryl group, in particular phenyl,

R¹² is hydrogen, a C₁-C₁₀-alkyl group, a C₆-C₁₂-aryl group or —OR¹³

R¹³ is a C₁-C₈-alkyl group, or C₆-C₁₂-aryl group, optionally substituted by O— or N— containing groups,

X is a chemical bond or a C₁-C₁₀-alkylene group or C₆-C₁₂-arylene group, or

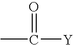

Y is O—Z or NH—Z, and

Z is a C₁-C₁₀ -alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of the type in which at least one reactive group polymerizes at about the same rate as the other monomers, while the other reactive group (or reactive groups), for example, polymerize(s) significantly more slowly. The different polymerization rates give rise to a certain proportion of double-bond unsaturation in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl |
| | acrylate, ethylhexyl acrylate, | methacrylate |
| | or a mixture of these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, methyl | first envelope composed of |
| | methacrylate, or a mixture | monomers as described under I |
| | of these | and II for the core, second |
| | | envelope as described under |
| | | I or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Examples of further conventional additives C) are stabilizers and oxidation retarders, agents to counteract decomposition by heat and decomposition by ultraviolet light, lubricants and mold-release agents, dyes, pigments, and plasticizers. The amounts generally comprised of pigments and dyes are up to 4% by weight, preferably from 0.5 to 3.5% by weight, and in particular from 0.5 to 3% by weight.

The pigments for pigmenting thermoplastics are well known (see, for example, R. Gächter and H. Müller, Taschenbuch der Kunststoffadditive [Plastics additives handbook], Carl Hanser Verlag, 1983, pp. 494 to 510. A first preferred group of pigments is that of white pigments, such as zinc oxide, zinc sulfide, white lead (2 PbCO3.Pb(OH)2), lithopones, antimony white and titanium dioxide. Of the two most commonly encountered crystalline forms (rutile and anatase) of titanium dioxide it is in particular the rutile form which is used for white coloration of the inventive molding compositions.

Black color pigments which can be used according to the invention are iron oxide black (Fe3O4), spinel black (Cu(Cr,Fe)2O4), manganese black (a mixture composed of manganese dioxide, silicon dioxide, and iron oxide), cobalt black, and antimony black, and also particularly preferably carbon black, mostly used in the form of furnace black or gas black (in which connection see G. Benzing, Pigmente für Anstrichmittel [Pigments for paints], Expert-Verlag (1988), pp. 78 et seq.).

According to the invention, it is possible, of course, to achieve particular shades by using inorganic chromatic pigments, such as chromium oxide green, or organic chromatic pigments, such as azo pigments or phthalocyanines. Pigments of this type are widely available commercially.

It can also be advantageous to use the pigments or dyes mentioned in a mixture, e.g. carbon black with copper phthalocyanines, because the result is generally easier dispersion of the color in the thermoplastic.

Examples of oxidation retarders and heat stabilizers which may be added to the thermoplastic materials according to the invention are halides of metals of group I of the periodic table of the elements, e.g. sodium halides, potassium halides and lithium halides, if appropriate in combination with cuprous halides, e.g. with chlorides, with bromides, and with iodides. The halides, in particular of copper, can also comprise electron-rich p-ligands. Cu halide complexes with, for example, triphenylphosphine may be mentioned as an example of these copper complexes. It is also possible to use zinc fluoride and zinc chloride. It is also possible to use sterically hindered phenols, hydroquinones, substituted representatives of this group, secondary aromatic amines, if appropriate in combination with phosphorus-comprising acids, or their salts, and mixtures of these compounds, preferably at concentrations of up to 1% by weight, based on the weight of the mixture.

Examples of UV stabilizers are various substituted resorcinols, salicylates, benzotriazoles, and benzophenones, the amounts used generally being up to 2% by weight.

Lubricants and mold-release agents, generally used in amounts of up to 1% by weight of the thermoplastic material, are stearic acid, stearyl alcohol, alkyl stearates, and stearamides, and also esters of pentaerythritol with long-chain fatty acids. It is also possible to use stearates of calcium, of zinc, or of aluminum, or else dialkyl ketones, such as distearyl ketone.

Among the additives are also stabilizers which inhibit decomposition of red phosphorus in the presence of moisture and atmospheric oxygen. Examples which may be mentioned are compounds of cadmium, of zinc, of aluminum, of tin, of magnesium, of manganese, and of titanium. Examples of particularly suitable compounds are oxides of the metals mentioned, and also carbonates or oxycarbonates, hydroxides, or else salts of organic or of inorganic acids, e.g. acetates or phosphates, or hydrogenphosphates.

The only flame retardants that will be mentioned here are red phosphorus and the other flame retardants known per se for polymer.

When components B) -D) are present, the inventive thermoplastic molding compositions can be prepared by processes known per se, by mixing the starting components in conventional mixing apparatuses, such as screw extruders, Brabender mixers, or Banbury mixers, and then extruding them. Component B) here can be premixed or fed in the form of aqueous emulsion dispersion or in the form of copolymer powder. The extrudate is cooled and comminuted.

The inventive molding compositions feature improved mechanical properties, such as good impact resistance and high tensile strain at break. In particular, they have problem-free thermoplastic processability and are accordingly suitable for production of fibers, of foils, and of moldings. Fiber-reinforced moldings have a very good surface, making them particularly suitable for applications in vehicle construction and for electrical and electronic applications.

Other preferred application sectors are crash-relevant applications (motor vehicle sector), since relatively high energy absorption is possible.

### EXAMPLES

The following components were used:

### Component A/1:

Polybutylene terephthalate (PBT) whose viscosity number VN is 130 ml/g, measured to DIN 53728 or ISO 1628 on a 0.5% strength by weight solution in a 1:1 mixture composed of phenol and o-dichlorobenzene at 25° C., and whose carboxy end group content is 34 meq/kg. The commercially available product Ultradur® B 4520 from BASF was used. The PBT comprises, as

component C1,

an amount of 0.65% by weight, based on 100% by weight of component A, of pentaerythritol tetrastearate.

Component A/2:

Nylon-6,6, e.g. Ultramid® A3, characterized by a viscosity number of 150 ml/g (measured in 0.5% strength by weight sulfuric acid at 25° C. to ISO 307), comprising, as

componente C/2,

0.2% by weight of Irganox® 1098 antioxidant from Ciba, based on A),

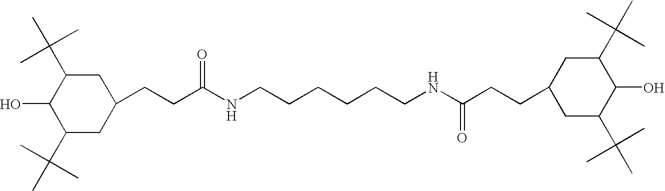

### Component A/3:

Nylon-6, e.g. Ultramid® B3, characterized by a viscosity number of 150 ml/g, comprising 0.2% by weight of component C/2.

### Component A/4:

Nylon-6, e.g. Ultramid® B3, characterized by a viscosity number of 150 ml/g.

### Component C/3:

Glass fibers whose average diameter is 10 μm.

### Component C/4:

Ca montanate.

### Preparation of Aqueous Copolymer dispersions

1) For PBT compounded materials

### Copolymer Dispersion B1 (“TCON 134”)

1297 g of deionized water and 50 g of a 20% strength by weight aqueous alkylaryl-sulfonate solution (Disponil LDBS 20 from Cognis) were used as initial charge in a 5 L pressure reactor, equipped with MIC stirrer and 4 feed units, at room temperature under nitrogen. The contents of the reactor were then heated to 80° C., with stirring, and once 80° C. had been reached, 101 g of a 7% strength by weight aqueous sodium persulfate solution were added. The entire amount of feed 1A was then fed within a period of 80 minutes and, with a time shift and beginning after 30 minutes, feed 2 was fed within a period of 65 minutes, in each case continuously with constant flow rates. Directly after the end of feed 1A, feed 1 B was started and fed within a period of 15 minutes continuously with constant flow rates. The contents of the reactor were then allowed to continue reacting for a further 5 hours at 80° C. The contents of the reactor were then cooled to room temperature and the pressure vessel was depressurized to atmospheric pressure. The coarse fractions were removed from the dispersion via filtration by way of a sieve (mesh width 100 micrometers).

### Feed 1A

Homogeneous emulsion composed of
300 g of deionized water
135 g of 20% strength by weight of aqueous alkylarylsulfonate solution (Disponil LDBS 20 from Cognis)
45 g of acrylonitrile
817.5 g of styrene
37.5 g of divinylbenzene (from Merck, 65% of active substance)

### Feed 1 B

Homogeneous emulsion composed of
65 g of deionized water
15 g of 20% strength by weight aqueous alkylarylsulfonate solution (Disponil LDBS 20 from Cognis)
20 g of acrylonitrile
60 g of styrene
20 g of divinylbenzene (from Aldrich, 65% of active substance)

### Feed 2

57 g of a 7% strength by weight aqueous sodium persulfate solution

The solids content of the resultant aqueous copolymer dispersion B1 was 34.5% by weight, based on the total weight of the aqueous dispersion. Glass transition temperature was determined as 114° C. and particle size was determined as 57 nm.

### Copolymer Dispersion B2 (“TCON 147”)

1297 g of deionized water and 50 g of a 20% strength by weight aqueous alkylaryl-sulfonate solution (Disponil LDBS 20 from Cognis) were used as initial charge in a 5 L pressure reactor, equipped with MIC stirrer and 4 feed units, at room temperature under nitrogen. The contents of the reactor were then heated to 80° C., with stirring, and once 80° C. had been reached, 95 g of a 0.75% strength by weight aqueous sodium persulfate solution were added. The entire amount of feed 1A was then fed within a period of 80 minutes and, with a time shift and beginning after 30 minutes, feed 2 was fed within a period of 65 minutes, in each case continuously with constant flow rates. Directly after the end of feed 1A, feed 1B was started and fed within a period of 15 minutes continuously with constant flow rates. The contents of the reactor were then allowed to continue reacting for a further 5 hours at 80° C. The contents of the reactor were then cooled to room temperature and the pressure vessel was depressurized to atmospheric pressure. The coarse fractions were removed from the dispersion via filtration by way of a sieve (mesh width 100 micrometers).

### Feed 1A

Homogeneous emulsion composed of
300 g of deionized water
135 g of 20% strength by weight of aqueous alkylarylsulfonate solution (Disponil LDBS 20 from Cognis)
862.5 g of styrene
37.5 g of divinylbenzene (from Merck, 65% of active substance)

### Feed 1 B

Homogeneous emulsion composed of
65 g of deionized water
15 g of 20% strength by weight aqueous alkylarylsulfonate solution (Disponil LDBS 20 from Cognis)
20 g of methyl methacrylate
60 g of styrene
20 g of divinylbenzene (from Aldrich, 65% of active substance)

### Feed 2

53 g of a 0.95% strength by weight aqueous sodium persulfate solution

The solids content of the resultant aqueous copolymer dispersion B2 was 34.2% by weight, based on the total weight of the aqueous dispersion. Glass transition temperature was determined as 120° C. and particle size was determined as 77 nm.

### Copolymer Dispersion B3 (“TCON 150”)

1297 g of deionized water and 50 g of a 20% strength by weight aqueous alkylaryl-sulfonate solution (Disponil LDBS 20 from Cognis) were used as initial charge in a 5 L pressure reactor, equipped with MIC stirrer and 4 feed units, at room temperature under nitrogen. The contents of the reactor were then heated to 80° C., with stirring, and once 80° C. had been reached, 101 g of a 7% strength by weight aqueous sodium persulfate solution were added. The entire amount of feed 1A was then fed within a period of 70 minutes and, with a time shift and beginning after 30 minutes, feed 2 was fed within a period of 70 minutes, in each case continuously with constant flow rates. Directly after the end of feed 1A, feed 1B was started and fed within a period of 30 minutes continuously with constant flow rates. The contents of the reactor were then allowed to continue reacting for a further 5 hours at 80° C. The contents of the reactor were then cooled to room temperature and the pressure vessel was depressurized to atmospheric pressure. The coarse fractions were removed from the dispersion via filtration by way of a sieve (mesh width 100 micrometers).

### Feed 1A

Homogeneous emulsion composed of
235 g of deionized water
120 g of 20% strength by weight of aqueous alkylarylsulfonate solution (Disponil LDBS 20 from Cognis)
760 g of styrene
40 g of divinylbenzene (from Merck, 65% of active substance)

### Feed 1 B

Homogeneous emulsion composed of
130 g of deionized water
30 g of 20% strength by weight aqueous alkylarylsulfonate solution (Disponil LDBS 20 from Cognis)
40 g of methyl methacrylate
120 g of styrene
40 g of divinylbenzene (from Aldrich, 65% of active substance)

### Feed 2

57 g of a 7% strength by weight aqueous sodium persulfate solution

The solids content of the resultant aqueous copolymer dispersion B3 was 34.6% by weight, based on the total weight of the aqueous dispersion. Glass transition temperature was determined as 122° C. and particle size was determined as 85 nm.

2) For PA compounded materials

### Copolymer Dispersion B4 (“TCON 102”)

1297 g of deionized water and 50 g of a 20% strength by weight aqueous alkylaryl-sulfonate solution (Disponil LDBS 20 from Cognis) were used as initial charge in a 5 L pressure reactor, equipped with MIC stirrer and 4 feed units, at room temperature under nitrogen. The contents of the reactor were then heated to 80° C., with stirring, and once 80° C. had been reached, 101 g of a 7% strength by weight aqueous sodium persulfate solution were added. The entire amount of feed 1 was then fed within a period of 90 minutes and, with a time shift and beginning after 30 minutes, feed 2 was fed within a period of 60 minutes, in each case continuously with constant flow rates. The contents of the reactor were then allowed to continue reacting for a further 5 hours at 80° C. The contents of the reactor were then cooled to room temperature and a pressure vessel was depressurized to atmospheric pressure. The coarse fractions were removed from the dispersion via filtration by way of a sieve (mesh width 100 micrometers).

### Feed 1

Homogeneous emulsion composed of
350 g of deionized water
150 g of 20% strength by weight of aqueous alkylarylsulfonate solution (Disponil LDBS 20 from Cognis)
950 g of styrene
50 g of divinylbenzene (from Merck, 65% of active substance)

### Feed 2

57 g of a 7% strength by weight aqueous sodium persulfate solution

The solids content of the resultant aqueous copolymer dispersion B4 was 33.3% by weight, based on the total weight of the aqueous dispersion. Glass transition temperature was determined as 119° C. and particle size was determined as 52 nm.

Copolymer dispersion B5 (“TCON 177+178”)

Copolymer dispersion Dxy was prepared analogously to the preparation of copolymer dispersion Daa except that the following constitution was selected for the feeds 1A, 1B, and 2:

### Feed 1A

homogeneous emulsion composed of
300 g of deionized water
135 g of 20% strength by weight aqueous alkylarylsulfonate solution (Disponil LDBS 20 from Cognis)
862.5 g of styrene
37.5 g of divinylbenzene (from Merck, 65% of active substance)

### Feed 1B

homogeneous emulsion composed of
65 g of deionized water
15 g of 20% strength by weight aqueous alkylarylsulfonate solution (Disponil LDBS 20 from Cognis)
20 g of glycidyl methacrylate
60 g of styrene
20 g of divinylbenzene (from Aldrich, 65% of active substance)

### Feed 2

57 g of a 7% strength by weight aqueous sodium persulfate solution

The solids content of the resultant aqueous copolymer dispersion B5 was 35.1% by weight, based on the total weight of the aqueous dispersion. Glass transition temperature was determined as 119° C. and particle size was determined as 80 nm.

Solids contents were generally determined by drying a defined amount of the respective aqueous copolymer dispersion (about 5 g) at 140° C. in a drying cabinet, to constant weight. In each case, two separate measurements were carried out. The values stated in the examples are the average of these two test results.

Glass transition temperature was determined to DIN 53765 by means of DSC820 equipment, series TA8000, from Mettler-Toledo Int. Inc.

The average diameter of the polymer particles was determined via dynamic light scattering on an aqueous polymer dispersion of strength from 0.005 to 0.01% by weight, at 23° C., by means of an Autosizer IIC from Malvern Instruments, England. The value stated is the average diameter from the cumulative evaluation (cumulant z average) from the autocorrelation function measured (ISO standard 13321).

### Preparation of Spray-Dried Polymer Powder

Spray drying took place in a Minor laboratory dryer from GEA Wiegand GmbH (Niro division) with twin-fluid-nozzle atomization and powder deposition in a fabric filter. The temperature of the nitrogen on inlet to the tower was 130° C. and the outlet temperature was 60° C. 2 kg of a spray feed were fed per hour.

The spray feed used comprised dispersions B1, B2, B3, B4, and B5, which had been adjusted in advance to solids content of 25% by weight, using deionized water.

Simultaneously with the spray feed, 0.4% by weight of the hydrophobic antiblocking agent Sipernat© D 17, based on the solids content of the spray feed, were fed continuously into the top of the spray tower by way of a weight-controlled twin screw.

The hydrophobic antiblocking agent Sipernat© D 17 from Degussa is a precipitated silica whose specific surface area (based on ISO 5794-1, Annex D) is 100 m²/g, with average particle size (based on ASTM C690-1992) of 7 micrometers, and with tamped bulk density (based on ISO 787-11) of 150 g/L, its surface having been hydrophobicized via treatment with specific chlorosilanes.

Spray drying gave the corresponding dispersion powders in the following yields: B1: 91%, B2: 92%, B3: 92%, B4: 79%, and B5: 92%.

### Preparation of Molding Compositions

Components B) were compounded in a twin-screw extruder (ZSK 30) at a temperature of
a) 260° C. for PBT and PA 6
b) 280° C. for nylon-6,6

The following mechanical tests were undertaken:
ISO 527-2 tensile test
ISO 179-2/1 eU flexural impact test at 23° C., 50% rel. humidity,
ISO 179-2 flexural impact test at −30° C.,
ISO 179-2/1 eA(S) flexural impact test at 23° C., 50% rel. humidity

The constitutions of the molding compositions and the results of the tests are found in the tables.

TABLE 1
Polyester molding compositions

| | Example | | | | |
|---|---|---|---|---|---|
| | 1 comp | 2 | 3 | 4 | 5 |
| Comp. A | 100 A/1 | 99.7 | 99.8 | 99.2 | 99.8 |
| [% by weight] | | | | | |
| Comp. B | — | 0.3 B1 | 0.2 B/2 | 0.8 B/3 | 0.2 B/3 |
| Modulus of | 2575 | 2574 | 2557 | 2514 | 2535 |
| elasticity | | | | | |
| [MPa] | | | | | |
| Tensile strain | 42.3 | 59 | 134 | 170 | 202.6 |
| at break | | | | | |
| [%] | | | | | |
| Charpy | 244 | 237 | 288 | 282 | 283 |
| [kJ/m²] 23° C. | | | | | |
| Charpy | 147 | 195 | 215 | 203 | 212 |
| [kJ/m²] −30° C. | | | | | |
| Charpy | 4.5 | 4.8 | 5.6 | 5.7 | 5.8 |
| notched | | | | | |
| [kJ/m²] 23° C. | | | | | |

TABLE 2
Polyamides

| | Example | | | | | | |
|---|---|---|---|---|---|---|---|
| | 1 comp | 2 | 3 | 4 comp | 5 | 6 comp | 7 |
| B | | 2 B/4 | 0.8 B/5 | | 2 B/4 | | 5 B/4 |
| [% by weight] | | | | | | | |
| Polyamide | 100 A/2 | 98 A/2 | 99.2 A/2 | 100 A/3 | 98 A/3 | 100 A/4 | 74.6 A/4 |
| [% by weight] | | | | | | | |
| C/3 | | | | | | | 20 |
| C/2 | | | | | | | 0.2 |
| C/4 | | | | | | | 0.2 |
| ISO 527-2: 1993 | 3398 | 3404 | 3528 | 3353 | 3260 | 7299 | 7217 |
| Tensile test: | | | | | | | |
| Modulus of elasticity | | | | | | | |
| [MPa] | | | | | | | |
| ISO 527-2: 1993 | 3.9 | 17.3 | 7.8 | 10.7 | 20.4 | 3.1 | 3.6 |
| Tensile test: | | | | | | | |
| Tensile strain at break | | | | | | | |
| [%] | | | | | | | |
| ISO 179-2/1eA(S) | 2.4 | 3.3 | 5.7 | 4.2 | 6.5 | | |
| 23° C./50% | | | | | | | |
| Charpy [kJ/m²] | | | | | | | |
| ISO 179-2/1eU, | | | | | | 57.8 | 72.7 |
| 23° C./50% | | | | | | | |
| Charpy [kJ/m²] | | | | | | | |

1. A thermoplastic molding composition, comprising:
A) from 10 to 99.9% by weight of a thermoplastic polymer;
B) from 0.01 to 10% by weight of a copolymer obtainable via free-radical-initiated aqueous emulsion polymerization of ethylenically unsaturated monomers in the presence of at least one dispersing agent and of at least one free-radical initiator by the feed process, where the emulsion polymerization uses comprises:
from 70 to 99.5% by weight of α,β-monoethylenically unsaturated compounds [monomers A], and
from 0.5 to 30% by weight of compounds having at least two ethylenically unsaturated groups capable of free-radical copolymerization [monomers B], and also, if appropriate,
up to 5% by weight of α,β-monoethylenically unsaturated mono- or dicarboxylic acids having from 3 to 6 carbon atoms and/or their amides [monomers C],
wherein the monomers A to C give a total of 100% by weight (entire amount of monomers) and the monomer feeds take place in such a way that ≧60% by weight of the entire amount of monomers B are fed to the polymerization mixture under polymerization conditions at a juncture after ≧60% by weight of the entire amount of monomer have been fed to the polymerization mixture under polymerization conditions,
C) from 0 to 70% by weight of further additives;
wherein the total of the percentages by weight of components A) to C) gives 100%.

2. The molding composition according to claim 1, where from 1 to 20% by weight of monomers B are used for preparation of component B).

3. The molding composition according to claim 1, where from 2 to 10% by weight of monomers B are used for preparation of component B).

4. The molding composition according to claim 1, where ≧60% by weight and ≦95% by weight of the entire amount of monomers B are fed for preparation of component B).

5. The molding composition according to claim 1, where, during the preparation of B), the monomers B are fed at a juncture after ≧70% by weight of the entire amount of monomers have been fed to the polymerization mixture under polymerization conditions.

6. The molding composition according to claim 1, where the nature and amount of the monomers A and of the monomers C is selected in such a way that the glass transition temperature of a copolymer B) composed solely of these monomers would be ≧40° C.

7. The molding composition according to claim, 1, in which component B) is added in the form of aqueous dispersion or in the form of powder during the compounding of components A) to C).

8. (canceled)

9. A molding, fiber, or foil obtainable from the thermoplastic molding compositions according to claim 1.

10. The molding composition according to claim 2, where from 2 to 10% by weight of monomers B are used for preparation of component B).

11. The molding composition according to claim 2, where ≧60% by weight and ≦95% by weight of the entire amount of monomers B are fed for preparation of component B).

12. The molding composition according to claim 3, where ≧60% by weight and ≦95% by weight of the entire amount of monomers B are fed for preparation of component B).

13. The molding composition according to claim 2, where, during the preparation of B), the monomers B are fed at a juncture after ≧70% by weight of the entire amount of monomers have been fed to the polymerization mixture under polymerization conditions.

14. The molding composition according to claim 3, where, during the preparation of B), the monomers B are fed at a juncture after ≧70% by weight of the entire amount of monomers have been fed to the polymerization mixture under polymerization conditions.

15. The molding composition according to claim 4, where, during the preparation of B), the monomers B are fed at a juncture after ≧70% by weight of the entire amount of monomers have been fed to the polymerization mixture under polymerization conditions.

16. The molding composition according to claim 2, where the nature and amount of the monomers A and of the monomers C is selected in such a way that the glass transition temperature of a copolymer B) composed solely of these monomers would be ≧40° C.

17. The molding composition according to claim 3, where the nature and amount of the monomers A and of the monomers C is selected in such a way that the glass transition temperature of a copolymer B) composed solely of these monomers would be ≧40° C.

18. The molding composition according to claim 4, where the nature and amount of the monomers A and of the monomers C is selected in such a way that the glass transition temperature of a copolymer B) composed solely of these monomers would be ≧40° C.

19. The molding composition according to claim 5, where the nature and amount of the monomers A and of the monomers C is selected in such a way that the glass transition temperature of a copolymer B) composed solely of these monomers would be ≧40° C.

20. The molding composition according to claim 2, in which component B) is added in the form of aqueous dispersion or in the form of powder during the compounding of components A) to C).
